(19) United States
(12) Patent Application Publication
(10) Pub. No.: US 2008/0086013 A1
(43) Pub. Date: Apr. 10, 2008

(54) CARBOMETALLATION OF ALKYNES AND IMPROVED SYNTHESIS OF UNIQUINONES

(75) Inventor: Bruce H. Lipshutz, Goleta, CA (US)

Correspondence Address: MORGAN, LEWIS & BOCKIUS LLP (SF), 2 PALO ALTO SQUARE, 3000 El Camino Real, Suite 700, PALO ALTO, CA, 94306, US

(73) Assignee: THE REGENTS OF THE UNIVERSITY OF CALIFORNIA, Oakland, CA (US)

(21) Appl. No.: 11/764,172

(22) Filed: Jun. 15, 2007

Related U.S. Application Data
(60) Provisional application No. 60/804,920, filed on Jun. 15, 2006.

(51) Int. Cl. C07F 5/06

(52) U.S. Cl. 556/190

(57) ABSTRACT

Methods for the carbometallation of alkynes are presented. Those are useful for the synthesis of CoQ₁₀ and other ubiquinones as well as for the synthesis of ubiquinol analogs.

### CROSS-REFERENCE TO RELATED APPLICATIONS

This application claims priority to U.S. Provisional Patent Application Ser. No. 60/804,920 filed on Jun. 15, 2006, which are herein incorporated by reference in their entirety for all purposes.

### BACKGROUND OF THE INVENTION

The ubiquinones, also commonly called coenzyme Qₙ (n=1-12), constitute essential cellular components of many life forms. In humans, CoQ₁₀ is the predominant member of this class of polyprenoidal natural products and is well-known to function primarily as a redox carrier in the respiratory chain (Lenaz, COENZYME Q. BIOCHEMISTRY, BIOENERGETICS, AND CLINICAL APPLICATIONS OF UBIQUINONE, Wiley-Interscience: New York (1985); Trumpower, FUNCTION OF UBIQUINONES IN ENERGY CONSERVING SYSTEMS, Academic Press, New York (1982); Thomson, R. H., NATURALLY OCCURRING QUINONES, 3rd ed., Academic Press, New York (1987); Bliznakov et al., THE MIRACLE NUTRIENT COENZYME Q₁₀, Bantom Books, New York (1987)).

Coenzyme Q plays an essential role in the orchestration of electron-transfer processes necessary for respiration. Almost all vertebrates rely on one or more forms of this series of compounds that are found in the mitochondria of every cell (i.e., they are ubiquitous, hence the alternative name “ubiquinones”). Although usually occurring with up to 12 prenoidal units attached to a p-quinone headgroup, CoQ₁₀ is the compound used by humans as a redox carrier. Oftentimes unappreciated is the fact that when less than normal levels are present, the body must construct its CoQ₁₀ from lower forms obtained through the diet, and that at some point in everyone's life span the efficiency of that machinery begins to drop. (Blizakov et al, supra) The consequences of this in vivo deterioration can be substantial; levels of CoQ₁₀ have been correlated with increased sensitivity to infection (i.e., a weakening of the immune system), strength of heart muscle, and metabolic rates tied to energy levels and vigor. In the United States, however, it is considered a dietary supplement, sold typically in health food stores or through mail order houses at reasonable prices. It is indeed fortunate that quantities of CoQ₁₀ are available via well-established fermentation and extraction processes (e.g., Sasikala et al., Adv. Appl. Microbiol., 41:173 (1995); U.S. Pat. Nos. 4,447,362; 3,313,831; and 3,313,826) an apparently more cost-efficient route relative to total synthesis. However, for producing lower forms of CoQ, such processes are either far less efficient or are unknown. Thus, the costs of these materials for research purposes are astonishingly high, e.g., CoQ₆ is $22,000/g, and CoQ₉ is over $40,000/g. (Sigma-Aldrich Catalog, Sigma-Aldrich: St. Louis, pp. 306-307 (1998)).

Several approaches to synthesizing the ubiquinones have been developed over the past 3-4 decades, attesting to the importance of these compounds. Recent contributions have invoked such varied approaches as Lewis acid-induced prenoidal stannane additions to quinones, (Naruta, J. Org. Chem., 45:4097 (1980)) reiterative Pd(0)-catalyzed couplings of doubly activated prenoidal chains with allylic carbonates bearing the required aromatic nucleus in protected form (Eren et al., J. Am. Chem. Soc., 110:4356 (1988) and references therein), and a Diels-Alder, retro Diels-Alder route to arrive at the quinone oxidation state directly (Van Lient et al., Rec. Trav. Chim. Pays-Bays 113:153 (1994); and Rüttiman et al., Helv. Chim. Acta, 73:790 (1990)). Nonetheless, all are lengthy, linear rather than convergent, and/or inefficient. Moreover, problems in controlling double bond stereochemistry using, e.g., a copper(I)-catalyzed allylic Grignard-allylic halide coupling can lead to complicated mixtures of geometrical isomers that are difficult to separate given the hydrocarbon nature of the side chains (Yanagisawa, et al, Synthesis, 1130 (1991)).

Another method of producing ubiquinones has been developed by Negishi (Negishi, Org. Lett. 4(2): 261-264 (2002)). In this publication, Negishi describes a traditional carboalumination of unactivated alkynes. This method possesses some characteristics that limit its applicability for industrial uses. For example, Negishi carboalumination generates at best 95:5 mixtures of regioisomers, and even worse depending upon solvent (toluene 90:10), making separation on an industrial scale prohibitive. In addition, the reactions in Negishi are conducted in chlorinated solvents, which can constitute a significant waste removal expense. In addition, the use of large amounts of ≧25 mole % of a zirconocene species in the carboalumination reaction creates vinylic alanes in the presence of zirconium salts that perform with less than optimal efficiency in subsequent coupling reactions with key chloromethylated quinones as substrates. Thus, the zirconocene salts necessitate their costly separation from the vinylalane to be used in the coupling, significantly impacting the economic costs of the process.

For the reasons set forth above, a convergent method for the synthesis of the ubiquinones and their analogues which originates with a simple benzenoid precursor and proceeds with retention of the double bond stereochemistry would represent a significant advance in the synthesis of ubiquinones and their analogues. The present invention provides such a method and ubiquinone precursors of use in the method.

### SUMMARY OF THE INVENTION

The present invention provides novel and cost-effective methods for the preparation of ubiquinones and structural analogues of these essential molecules. The invention further provides novel methods for the carbometallation of alkyne substrates. Carbometallated intermediates are formed with high regioselectivity, utilizing reduced amounts of common carbometallation catalysts, thereby increasing yields, reducing waste products and simplifying subsequent synthetic procedures. The carbometallated species produced by the methods of the invention are useful, for instance, for the preparation of CoQ₁₀ and CoQ analogs.

Thus, in a first aspect, the present invention provides a method of carboaluminating an alkyne substrate, forming a vinylalane with at least 90% regioselectivity. This method comprises: (a) contacting said alkyne substrate and Al(L)ₚ₊₁ and an additive which is a member selected from substituted or unsubstituted alkylaluminoxane, substituted or unsubstituted primary or secondary alkyl alcohols and substituted or unsubstituted primary or secondary alkyl thiols, in the presence of a carboalumination catalyst and a solvent, wherein each L is independently selected from substituted or unsubstituted alkyl, substituted or unsubstituted alkoxy, substituted or unsubstituted alkylthio, substituted or unsubstituted aryl, substituted or unsubstituted aryloxy and substituted or unsubstituted arylthio; and p is a member selected from 1 and 2. In an exemplary embodiment, there is a proviso that at least one of said L is attached to said Al through a carbon-aluminum bond. In an exemplary embodiment, there is a proviso that at least one of said L is a member selected from substituted or unsubstituted alkyl and substituted or unsubstituted aryl. In an exemplary embodiment, there is a proviso that at least one of said L is methyl. In an exemplary embodiment, there is a proviso that said substituted or unsubstituted primary or secondary alkyl alcohol is not methanol. In an exemplary embodiment, the additive is a member selected from isobutylaminoxane and isobutanol. In an exemplary embodiment, the regioselectivity is a member selected from at least 95%, at least 98% and at least 99%. In an exemplary embodiment, the alkyne substrate is a terminal alkyne. In another exemplary embodiment, the alkyne substrate has a formula which is a member selected from:

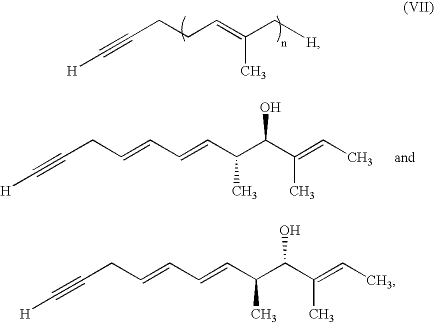

wherein n is an integer from 0 to 19. In an exemplary embodiment, the alkyne substrate is 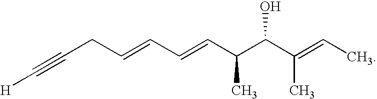
In another exemplary embodiment, the additive is used in an amount from about 0.01 to about 0.5 molar equivalents relative to said alkyne substrate. In another exemplary embodiment, the carboalumination catalyst is used in an amount of less than 0.3 molar equivalents relative to said alkyne substrate. In another exemplary embodiment, the carboalumination catalyst is used in an amount of less than 0.1 molar equivalents relative to said alkyne substrate. In another exemplary embodiment, the carboalumination catalyst is a member selected from zirconium-, titanium- and hafnium-containing species. In another exemplary embodiment, the carboalumination catalyst is selected from those described in U.S. patent application Ser. No. 11/304,203 filed on Dec. 15, 2005. In an exemplary embodiment, the carboalumination catalyst is a member selected from Brintzinger's catalyst and Cp₂ZrCl₂. In an exemplary embodiment, the solvent is a member selected from dichloroethane (DCE), dichloromethane (DCM), chlorobenzene, a non-chlorinated solvent and mixtures thereof. In an exemplary embodiment, the method further comprises: (b) prior to step (a), contacting said Al(L)ₚ₊₁ and said additive in the presence of a carboalumination catalyst and a solvent. In an exemplary embodiment, the non-chlorinated solvent is a member selected from trifluoromethylbenzene and toluene. In another exemplary embodiment, the contacting occurs for at least about 10 minutes.

In another exemplary embodiment, the method comprises: (a) contacting the alkyne substrate and Al(L)ₚ₊₁ and iso-butylaluminoxane (IBAO) or isobutanol in the presence of a carboalumination catalyst and a solvent, wherein each L is independently selected from substituted or unsubstituted alkyl, substituted or unsubstituted alkoxy, substituted or unsubstituted aryl and substituted or unsubstituted aryloxy and p is a member selected from 1 and 2. In another exemplary embodiment, the method further comprises: (c) contacting the product of step (a) with a compound of Formula: 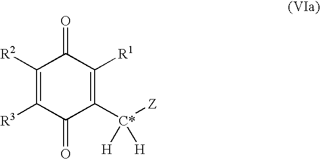
wherein Z is a leaving group; R¹, R² and R³ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl. R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl; wherein at least two of R¹, R² and R³, together with the carbon atoms to which they are attached, are optionally joined to form a 5- to 7-membered ring; and in the presence of a coupling catalyst effective at catalyzing coupling between said C* atom according to Formula (IV) and said vinyl alane of step (a), thereby forming a compound according to Formula (I): 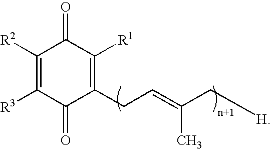
In an exemplary embodiment, R¹ is methyl; R² and R³ are methoxy and n is 9. In an exemplary embodiment, R¹ is H; R² and R³ are methyl and n is a member selected from 5-8. In an exemplary embodiment, the method further comprises: (c) contacting the product of step (a) with a compound which has a structure according to Formula (IV): 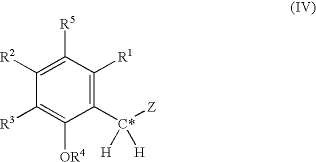
wherein Z is a leaving group; R¹, R², R³ and R⁵ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl; R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl; and at least two of R¹, R², R³ and R⁵, together with the carbon atoms to which they are attached, are optionally joined to form a 5- to 7-membered ring; R⁴ is a protecting group, in the presence of a coupling catalyst effective at catalyzing coupling between said C atom according to Formula (IV) and said vinyl alane of step (a). In an exemplary embodiment, the compound has a structure according to: 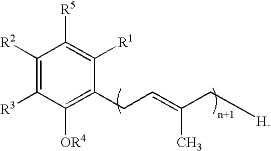
In another exemplary embodiment, the method further comprises: (c) contacting the product of step (a) with a compound which has a structure according to Formula: 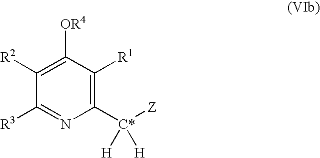
wherein R¹, R² and R³ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl; R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl; and at least two of R¹, R², R³ and R⁵, together with the carbon atoms to which they are attached, are optionally joined to form a 5- to 7-membered ring; and R⁴ is a protecting group, in the presence of a coupling catalyst effective at catalyzing coupling between said C* atom according to Formula (IV) and a vinyl alane of step (a). In an exemplary embodiment, said compound has a structure according to: 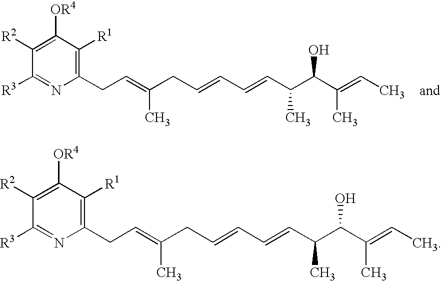
In an exemplary embodiment, the compound has a structure according to 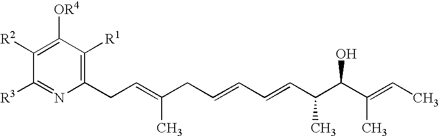
In an exemplary embodiment, R¹ is CH₃; R² and R³ are methoxy.

In another aspect, the invention provides a method of carboaluminating an alkyne substrate having a formula according to Formula (VII): 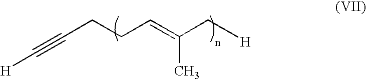
wherein n is an integer from 0 to 14, forming a vinylalane with at least 90% regioselectivity, said method comprising: (a) contacting said alkyne substrate of Formula (VII) and Al(CH₃)₃ and iso-butylaluminoxane (IBAO), in the presence of a carboalumination catalyst and a solvent. In an exemplary embodiment, the iso-butylaluminoxane is used in an amount from about 0.01 to about 0.5 molar equivalents relative to said alkyne substrate. In an exemplary embodiment, the carboalumination catalyst is a member selected from zirconium-, titanium- and hafnium-containing species. In an exemplary embodiment, the carboalumination catalyst is a member selected from Brintzinger's catalyst and Cp₂ZrCl₂. In an exemplary embodiment, the carboalumination catalyst is used in an amount of less than 0.3 molar equivalents relative to said alkyne substrate. In an exemplary embodiment, the solvent is a member selected from dichloroethane (DCE), dichloromethane (DCM), chlorobenzene, a non-chlorinated solvent and mixtures thereof. In an exemplary embodiment, the non-chlorinated solvent is a member selected from trifluoromethylbenzene and toluene. In an exemplary embodiment, the alkyne substrate is produced by: (i) forming a propyne dianion by contacting propyne with a base; and (ii) combining said propyne dianion with a compound having the formula: 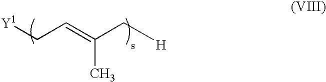
wherein Y¹ is a leaving group; and s is an integer from 1 to 19. In an exemplary embodiment, the method further comprises: (b) contacting the product of step (a) with a compound of Formula (V): 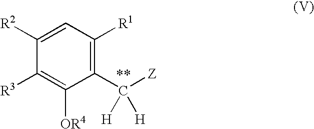
wherein Z is a leaving group; R¹, R², R³ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl; wherein R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl; and R² and R³, together with the carbon atoms to which they are attached, are optionally joined to form a 5- to 7-membered ring; and R⁴ is a protecting group; in the presence of a coupling catalyst effective at catalyzing coupling between said C** atom according to Formula (V) and said vinylalane of step (a), thereby forming a compound according to Formula (II): 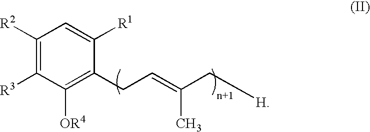
In an exemplary embodiment, step (b) is conducted essentially without prior isolation of the vinylalane of step (a).

In another aspect, the invention provides a method of carboaluminating an alkyne substrate having a formula according to Formula (VII): 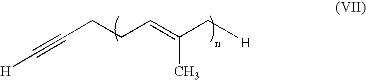
wherein n is an integer from 0 to 14, forming a vinylalane with at least 90% regioselectivity, said method comprising: (a) contacting said alkyne substrate of Formula (VII) and Al(CH₃)₃ and iso-butylaluminoxane (IBAO) in the presence of Cp₂ZrCl₂ and a solvent. In an exemplary embodiment, Cp₂ZrCl₂ is used in an amount less than 0.3 molar equivalents relative to said alkyne substrate. In an exemplary embodiment, the solvent is a member selected from dichloroethane (DCE), dichloromethane (DCM), chlorobenzene, a non-chlorinated solvent and mixtures thereof. In an exemplary embodiment, the non-chlorinated solvent is a member selected from trifluoromethylbenzene and toluene. In an exemplary embodiment, the alkyne substrate is produced by: (i) forming a propyne dianion by contacting propyne with a base; and (ii) contacting said propyne dianion with a compound having the formula: 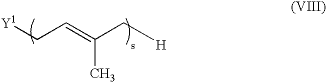
wherein Y¹ is a leaving group; s is an integer from 1 to 19. In an exemplary embodiment, the method further comprises: (b) contacting the product of step (a) with a compound of Formula (VI): 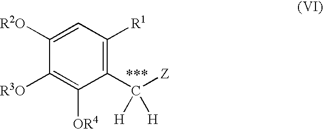
wherein Z is a leaving group; R¹ is a member selected from H and C₁-C₆ alkyl; R² and R³ are members independently selected from C₁-C₆ alkyl; and R⁴ is a protecting group, in the presence of a coupling catalyst effective at catalyzing coupling between said C*** atom according to Formula (VI) and said vinylalane of step (a), thereby forming a compound according to Formula (III): 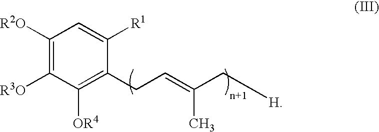
In an exemplary embodiment, step (b) is conducted essentially without prior isolation of the vinylalane of step (a). In an exemplary embodiment, n is 9. In an exemplary embodiment, the method further comprises: (c) removing R⁴, thereby producing a compound according to Formula (IX): 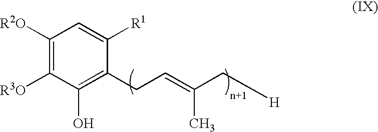
(d) contacting the compound according to Formula (IX) with an oxidant, thereby producing a compound according to Formula (X): 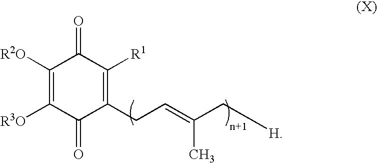
In an exemplary embodiment, step (c) is conducted essentially without prior purification of the product of step (b).

Thus, in another aspect, the present invention provides a method of carboaluminating an alkyne substrate, forming a vinylalane with at least 90% regioselectivity. The method comprises: (a) contacting the alkyne substrate and Al(L)ₚ₊₁ and iso-butylaluminoxane (IBAO) in the presence of a carboalumination catalyst and a solvent, wherein each L is independently selected from substituted or unsubstituted alkyl, substituted or unsubstituted alkoxy, substituted or unsubstituted aryl and substituted or unsubstituted aryloxy and p is a member selected from 1 and 2.

Thus, in another aspect, the present invention provides a method of carboaluminating an alkyne substrate, forming a vinylalane with at least 90% regioselectivity. This method comprises: (a) contacting a carboalumination catalyst and a solvent Al(L)ₚ₊₁ and an additive which is a member selected from substituted or unsubstituted alkylaluminoxane, substituted or unsubstituted primary or secondary alkyl alcohols and substituted or unsubstituted primary or secondary alkyl thiols; and (b) contacting the product of step (a) and said alkyne substrate. In an exemplary embodiment, the amount of time that elapses between step (a) and the start of step (b) is a member selected from about 5 minutes, about 10 minutes, about 15 minutes, about 20 minutes, about 25 minutes, about 30 minutes, about 35 minutes, about one hour, about 90 minutes, about two hours, about 150 minutes and about three hours. In an exemplary embodiment, the regioselectivity is a member selected from at least 95%, at least 98% and at least 99%. In another exemplary embodiment, the additive is a member selected from isobutylaluminoxane and isobutanol. In another exemplary embodiment, the alkyne substrate is 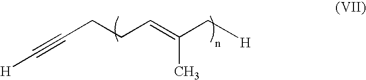
wherein n is an integer from 0 to 14, and the method further comprises: (c) contacting the product of step (b) with a compound of Formula: 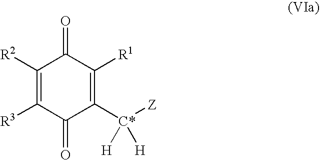
wherein Z is a leaving group; R¹, R² and R³ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl. R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl; wherein at least two of R¹, R² and R³, together with the carbon atoms to which they are attached, are optionally joined to form a 5- to 7-membered ring; and in the presence of a coupling catalyst effective at catalyzing coupling between said C* atom according to Formula (IV) and said vinyl alane of step (a), thereby forming a compound according to: 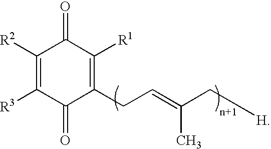
In an exemplary embodiment, R¹ is methyl; R² and R³ are methoxy and n is 9. In an exemplary embodiment, R¹ is H; R² and R³ are methyl and n is a member selected from 5-8.

In a second aspect, the invention provides a method of carboaluminating an alkyne substrate having a formula according to Formula (VII): 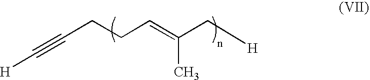
wherein n is an integer from 0 to 14, forming a vinylalane with at least 90% regioselectivity. The method comprises: (a) contacting the alkyne substrate of Formula (VII) and Al(CH₃)₃ and iso-butylaluminoxane (IBAO), in the presence of a carboalumination catalyst and a solvent. A preferred carboalumination catalyst is Cp₂ZrCl₂.

Unexpectedly, the inventors have discovered that carbometallation of an alkyne substrate using common and cheap carbometallation catalysts (e.g., Cp₂ZrCl₂) proceeds with high regioselectivity, preferably at least 90%, more preferably at least 95%, more preferably at least 98%, more preferably at least 99%, when the reaction is performed in the presence of an alkylaluminoxane other than methylaluminoxane (MAO). Previously, such high regioselectivity could only be obtained when using MAO in combination with less common and frequently more expensive carbometallation catalysts. The dramatic improvement of the regioselectivity when using cheap catalysts by replacing MAO with another alkylaluminoxane, such as IBAO (iso-buytlaluminoxane) is unexpected.

In addition, the use of alternative alkylaluminoxanes, such as IBAO, allows the amount of required carbometallation catalyst to be reduced significantly, while retaining high regioselectivity. In one embodiment, wherein Cp₂ZrCl₂ is used as the carbometallation catalyst, this amount is reduced by at least 5 times.

Further, the reduced amount of catalyst present in the reaction mixture makes it possible to eliminate certain purification or isolation steps. In one exemplary embodiment, salts derived from the catalyst do not have to be removed from the reaction mixture before the carbometallation product is used for subsequent coupling reactions. As a result the carbometallation product does not have to be transferred from one reaction vessel to another. In another exemplary embodiment, the high regioselectivity during the carbometallation step eliminates the need for purification after coupling of the carbometallation product to another substrate and before the coupling product is subjected to the next synthetic step.

The carbometallation procedure was further improved by modifying solvents and solvent mixtures. Unexpectedly, the inventors have discovered that certain solvents used in known processes can be replaced with other solvents, thereby maintaining or improving yields and simplifying process steps. In one embodiment, 1,2-dichloroethane was replaced and the amount of toluene was reduced by using a mixture of dichloromethane and chlorobenzene. By modifying solvents such that higher concentrations are realized for the carboalumination step, unexpectedly the subsequent coupling can be effected by simply diluting the more concentrated mixture with THF thereby avoiding solvent removal. This greatly simplifies the 1-pot process further.

Taken together, these novel parameters render overall processes, employing carbometallation of alkynes, more efficient and cost-effective. The methods of the invention are particularly useful for large-scale syntheses and industrial applications.

### BRIEF DESCRIPTION OF THE DRAWINGS

FIG. 1 sets forth exemplary intermediates and transformations of use in the methods of the invention.

### DETAILED DESCRIPTION OF THE INVENTION AND THE PREFERRED EMBODIMENTS

### I. Definitions

The term “alkyl,” by itself or as part of another substituent, means, unless otherwise stated, a straight or branched chain, or cyclic hydrocarbon radical, or combination thereof, which may be fully saturated, mono- or polyunsaturated and can include di- and multi-valent radicals, having the number of carbon atoms designated (i.e. C₁-C₁₀ means one to ten carbons). Examples of saturated hydrocarbon radicals include groups such as methyl, ethyl, n-propyl, isopropyl, n-butyl, t-butyl, isobutyl, sec-butyl, cyclohexyl, (cyclohexyl)ethyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to include those derivatives of alkyl defined in more detail below as “heteroalkyl,” “cycloalkyl” and “alkylene.” The term “alkylene” by itself or as part of another substituent means a divalent radical derived from an alkane, as exemplified by —CH₂CH₂CH₂CH₂—. Typically, an alkyl group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

The terms “alkoxy,” “alkylamino” and “alkylthio” refer to those groups having an alkyl group attached to the remainder of the molecule through an oxygen, nitrogen or sulfur atom, respectively. Similarly, the term “dialkylamino” is used in a conventional sense to refer to —NR′R″ wherein the R groups can be the same or different alkyl groups.

The term “acyl” or “alkanoyl” by itself or in combination with another term, means, unless otherwise stated, a stable straight or branched chain, or cyclic hydrocarbon radical, or combinations thereof, consisting of the stated number of carbon atoms and an acyl radical on at least one terminus of the alkane radical.

The term “heteroalkyl,” by itself or in combination with another term, means, unless otherwise stated, a stable straight or branched chain, or cyclic hydrocarbon radical, or combinations thereof, consisting of the stated number of carbon atoms and from one to three heteroatoms selected from the group consisting of O, N, Si and S, and wherein the nitrogen and sulfur atoms may optionally be oxidized and the nitrogen heteroatom may optionally be quaternized. The heteroatom(s) O, N and S may be placed at any interior position of the heteroalkyl group. The heteroatom Si may be placed at any position of the heteroalkyl group, including the position at which the alkyl group is attached to the remainder of the molecule. Examples include —CH₂—CH₂—O—CH₃, —CH₂—CH₂—NH—CH₃, —CH₂—CH₂—N(CH₃)—CH₃, —CH₂—S—CH₂—CH₃, —CH₂—CH₂—S(O)—CH₃, —CH₂—CH₂—S(O)₂—CH₃, —CH═CH—O—CH₃, —Si(CH₃)₃, —CH₂—CH═N—OCH₃, —Si(Me)₂-, —Si(CH(Me)₂)₂—, —Si(R²⁸C(Me)₃)-, —Si(Ph)₂-, —CH₂OSi(Me₂)OCH₂— and —CH═CH—N(CH₃)—CH₃. Up to two heteroatoms may be consecutive, such as, for example, —CH₂—NH—OCH₃ and —CH₂—O—Si(CH₃)₃. Also included in the term “heteroalkyl” are those radicals described in more detail below as “heteroalkylene” and “heterocycloalkyl.” The term “heteroalkylene” by itself or as part of another substituent means a divalent radical derived from heteroalkyl, as exemplified by —CH₂—CH₂—S—CH₂CH₂— and —CH₂—S—CH₂—CH₂—NH—CH₂—. For heteroalkylene groups, heteroatoms can also occupy either or both of the chain termini. Still further, for alkylene and heteroalkylene linking groups, no orientation of the linking group is implied.

The terms “cycloalkyl” and “heterocycloalkyl”, by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include cyclopentyl, cyclohexyl, 1-cyclohexenyl, 3-cyclohexenyl, cycloheptyl, and the like. Examples of heterocycloalkyl include 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like.

The terms “halo” or “halogen,” by themselves or as part of another substituent, mean, unless otherwise stated, a fluorine, chlorine, bromine, or iodine atom. Additionally, terms such as “fluoroalkyl,” are meant to include monofluoroalkyl and polyfluoroalkyl.

The term “aryl,” employed alone or in combination with other terms (e.g., aryloxy, arylthioxy, arylalkyl) means, unless otherwise stated, an aromatic substituent which can be a single ring or multiple rings (up to three rings), which are fused together or linked covalently. “Heteroaryl” are those aryl groups having at least one heteroatom ring member. Typically, the rings each contain from zero to four heteroatoms selected from N, O, and S, wherein the nitrogen and sulfur atoms are optionally oxidized, and the nitrogen atom(s) are optionally quaternized. The “heteroaryl” groups can be attached to the remainder of the molecule through a heteroatom. Non-limiting examples of aryl and heteroaryl groups include phenyl, cyclopentadienyl anion, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl ring systems are selected from the group of acceptable substituents described below. The term “arylalkyl” is meant to include those radicals in which an aryl group is attached to an alkyl group (e.g., benzyl, phenethyl, pyridylmethyl and the like) or a heteroalkyl group (e.g., phenoxymethyl, 2-pyridyloxymethyl, 3-(1-naphthyloxy)propyl, and the like).

Each of the above terms (e.g., “alkyl,” “heteroalkyl” and “aryl”) are meant to include both substituted and unsubstituted forms of the indicated radical. Preferred substituents for each type of radical are provided below.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) can be a variety of groups selected from, for example: hydrogen, -halogen, —R³³, —OH, —OR³³, —SH, —SR³³, —NH₂, —NO₂, —NR³³R³⁴, ═NR³³, ═N—OR³³, —CN, —N₃, —PR³³R³⁴, —SiR³³R³⁴R³⁵, —OSiR³³R³⁴R³⁵, C(O)OR³³, ═O, —OC(O)R³³, —C(O)R³³, —CO₂R³³, CONR³³R³⁴, —OC(O)NR³³R³⁴, —NR³³C(O)R³⁴, —NR³³—C(O)NR³⁴R³⁵, —NR³³C(O)₂R³⁴, —NH—C(NH₂)═NH, —NR′C(NH₂)═NH, —NH—C(NH₂)═NR³³, —S(O)R³³, —S(O)₂R³³, and —S(O)₂NR³³R³⁴ in a number ranging from zero to (2N+1), where N is the total number of carbon atoms in such radical. R³³, R³⁴ and R³⁵ each independently refer to hydrogen, substituted and unsubstituted alkyl, substituted and unsubstituted heteroalkyl, substituted and unsubstituted cycloalkyl, substituted and unsubstituted heterocycloalkyl, substituted and unsubstituted aryl, substituted and unsubstituted heteroaryl, aryl substituted with 1-3 halogens, unsubstituted alkyl, alkoxy or thioalkoxy groups, or aryl-(C₁-C₄)alkyl groups. When R³³ and R³⁴ are attached to the same nitrogen atom, they can be combined with the nitrogen atom to form a 5-, 6-, or 7-membered ring. For example, —NR³³R³⁴ is meant to include 1-pyrrolidinyl and 4-morpholinyl. From the above discussion of substituents, one of skill in the art will understand that the term “alkyl” is meant to include groups such as haloalkyl (e.g., —CF₃ and —CH₂CF₃) and acyl (e.g., —C(O)CH₃, —C(O)CF₃, —C(O)CH₂OCH₃, and the like).

Similarly, substituents for the aryl and heteroaryl groups are varied and are selected from: hydrogen, -halogen, —R³³, —OH, —OR³³, —SH, —SR³³, —NH₂, —NO₂, —NR³³R³⁴, ═NR³³, ═N—OR³³, —CN, —N₃, —PR³³R³⁴, —SiR³³R³⁴R³⁵, —OSiR³³R³⁴R³⁵, —C(O)OR³³, ═O, —OC(O)R³³, —C(O)R³³, —CO₂R³³, CONR³³R³⁴, —OC(O)NR³³R³⁴, —NR³³C(O)R³⁴, —NR³³—C(O)NR³⁴R³⁵, —NR³³C(O)₂R³⁴, —NH—C(NH₂)═NH, —NR′C(NH₂)═NH, —NH—C(NH₂)═NR³³, —S(O)R³³, —S(O)₂R³³, and —S(O)₂NR³³R³⁴, —CH(Ph)₂, perfluoro(C₁-C₄)alkoxy, and perfluoro(C₁-C₄)alkyl, in a number ranging from zero to the total number of open valences on the aromatic ring system; and where R³³, R³⁴ and R³⁵ each independently refer to hydrogen, substituted and unsubstituted alkyl, substituted and unsubstituted heteroalkyl, substituted and unsubstituted cycloalkyl, substituted and unsubstituted heterocycloalkyl, substituted and unsubstituted aryl, substituted and unsubstituted heteroaryl.

Two of the substituents on adjacent atoms of the aryl ring may optionally be replaced with a substituent of the formula -T-C(O)—(CH₂)_{q}—U—, wherein T and U are independently —NH—, —O—, —CH₂— or a single bond, and the subscript q is an integer of from 0 to 2. Alternatively, two of the substituents on adjacent atoms of the aryl ring may optionally be replaced with a substituent of the formula -A-(CH₂)ᵣ—B—, wherein A and B are independently —CH₂—, —O—, —NH—, —S—, —S(O)—, —S(O)₂—, —S(O)₂NR³³, or a single bond, and r is an integer of from 1 to 3. One of the single bonds of the new ring so formed may optionally be replaced with a double bond. Alternatively, two of the substituents on adjacent atoms of the aryl ring may optionally be replaced with a substituent of the formula —(CH₂)ₛ—X—(CH₂)ₜ—, where s and t are independently integers of from 0 to 3, and X is —O—, —NR³³—, —S—, —S(O)—, —S(O)₂—, or —S(O)₂NR³³—. The substituent R³³ in —NR³³— and —S(O)₂NR³³— is selected from hydrogen or unsubstituted (C₁-C₆)alkyl.

As used herein, the term “heteroatom” is meant to include, for example, oxygen (O), nitrogen (N), sulfur (S) and silicon (Si).

Certain compounds of the present invention possess asymmetric carbon atoms (optical centers) or double bonds; the racemates, diastereomers, geometric isomers and individual isomers are all encompassed within the scope of the present invention.

The compounds of the present invention may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the compounds of the present invention, whether radioactive or not, are intended to be encompassed within the scope of the present invention.

As used herein, the term “leaving group” refers to a portion of a substrate that is cleaved from the substrate in a reaction. The leaving group is an atom (or a group of atoms) that is displaced as stable species taking with it the bonding electrons. Typically the leaving group is an anion (e.g., Cl⁻) or a neutral molecule (e.g., H₂O). Exemplary leaving groups include a halogen, OC(O)R³⁶, OP(O)R³⁶R³⁷, OS(O)R³⁶, and OSO₂R³⁶. R³⁶ and R³⁷ are members independently selected from substituted or unsubstituted alkyl, substituted or unsubstituted aryl, substituted or unsubstituted heteroaryl and substituted or unsubstituted heterocycloalkyl. Useful leaving groups include, but are not limited to, other halides, sulfonic esters, oxonium ions, alkyl perchlorates, sulfonates, e.g., arylsulfonates, ammonioalkanesulfonate esters, and alkylfluorosulfonates, phosphates, carboxylic acid esters, carbonates, ethers, and fluorinated compounds (e.g., triflates, nonaflates, tresylates), S R³⁶, (R³⁶)₃P⁺, (R³⁶)₂S⁺, P(O)N(R³⁶)₂(R³⁶)₂, P(O)R³⁸R³⁶R³⁹R³⁶ in which each R³⁶ is independently selected from the members provided in this paragraph and R³⁸ and R³⁹ are each either S or O. The choice of these and other leaving groups appropriate for a particular set of reaction conditions is within the abilities of those of skill in the art (see, for example, March J, ADVANCED ORGANIC CHEMISTRY, 2nd Edition, John Wiley and Sons, 1992; Sandler S R, Karo W, ORGANIC FUNCTIONAL GROUP PREPARATIONS, 2nd Edition, Academic Press, Inc., 1983; and Wade L G, COMPENDIUM OF ORGANIC SYNTHETIC METHODS, John Wiley and Sons, 1980).

“Protecting group,” as used herein refers to a portion of a substrate that is substantially stable under a particular reaction condition, but which is cleaved from the substrate under a different reaction condition. A protecting group can also be selected such that it participates in the direct oxidation of the aromatic ring component of the compounds of the invention. For examples of useful protecting groups, see, for example, Greene et al., PROTECTIVE GROUPS IN ORGANIC SYNTHESIS, 3rd ed., John Wiley & Sons, New York, 1999.

“Adsorbent”, as used herein refers to a material with the property to hold molecules of fluids without causing a chemical or physical change. Examples are Silica gel, Alumina, Charcoal, Ion exchange resins and others, characterized by high surface/volume ratio.

“Metallocene”, as used herein, refers to a compound consisting of one or more aromatic organic ligands bound to a metal.

The term “regioselectivity” as used herein refers to the carbometallation reactions described herein, wherein one or more regioisomers are formed. For instance, when carboaluminating a terminal alkyne, two regioisomers of the resulting vinylalane may be formed, one in which the aluminum is attached to the terminal carbon atom (regioisomer 1), and another, in which the aluminum is attached to the second carbon atom (regioisomer 2). The reaction proceeds with e.g., 90% regioselectivity, when the ratio between regioisomer 1 and regioisomer 2 is 90:10.

### II. Introduction

Unexpectedly, the inventors have discovered that carbometallation of alkyne substrates using common and comparatively inexpensive carbometallation catalysts (e.g., Cp₂ZrCl₂) proceeds with high regioselectivity, preferably at least 95%, when the reaction is performed in the presence of an additive such as substituted or unsubstituted alkylaluminoxane other than methylaluminoxane (MAO), and/or a substituted or unsubstituted primary or secondary alkyl alcohols and/or substituted or unsubstituted primary or secondary alkyl thiols. Previously, such high regioselectivity could only be obtained when using MAO in combination with less common and frequently more expensive carbometallation catalysts. The dramatic improvement of the regioselectivity when using cheap catalysts by replacing MAO with another additive such as an alkylaluminoxane, such as IBAO (iso-buytlaluminoxane) or a substituted or unsubstituted primary or secondary alkyl alcohol, such as isobutanol, is unexpected.

In addition, the use of alternative alkylaluminoxanes, such as IBAO, allows the amount of required carboalumination catalyst to be reduced significantly, while retaining high regioselectivity.

Further, the reduced amount of carboalumination catalyst present in the reaction mixture makes it possible to eliminate certain purification or isolation steps. In one exemplary embodiment, salts derived from the carboalumination catalyst during a method described herein does not have to be removed from the reaction mixture before the carbometallation product is used for subsequent coupling reactions. As a result the carbometallation product does not have to be transferred from one reaction vessel to another. In another exemplary embodiment, the high regioselectivity during the carbometallation step eliminates the need for purification after coupling of the carbometallation product to another substrate and before the coupling product is subjected to the next synthetic step. In an exemplary embodiment, two or more steps of a method described herein can be performed without separating or purifying the product from the first step. In an exemplary embodiment, a coupling reaction described herein can take place in the same reaction vessel as a carboalumination reaction described herein without separating or purifying the carboalumination product. In an exemplary embodiment, the solvent from the carboalumination reaction is essentially removed, and then the coupling reactants and solvent are added to the carboalumination reaction vessel. In another exemplary embodiment, the solvent from the carboalumination reaction is essentially unremoved, and then the coupling reactants and solvent are added to the carboalumination reaction vessel.

The carbometallation procedure was further improved by modifying solvents and solvent mixtures. Unexpectedly, the inventors have discovered that certain solvents used in known processes can be replaced with other solvents, thereby maintaining or improving yields and simplifying process steps. In one embodiment, a mixture of dichloromethane and chlorobenzene is used instead of 1,2-dichloroethane and the amount of toluene is reduced.

In an exemplary embodiment, the combination of these novel parameters renders the overall product production (e.g. ubiquinones, phytoquinones, plastoquinones, piercidins such as piercidin A1) process more efficient and cost-effective. The methods of the invention are particularly useful for large-scale syntheses and industrial applications.

### III. Methods of the Invention

Techniques useful for synthesizing the compounds of the invention are both readily apparent and accessible to those of skill in the relevant art. The discussion below is offered to illustrate certain of the diverse methods available for use in assembling the compounds of the invention, it is not intended to define the scope of reactions or reaction sequences that are useful in preparing the compounds of the present invention.

Synthesis of the Starting Materials

The substituted methylene moieties of the invention are prepared by art-recognized methods or modifications thereof. For example, the synthesis of quinones functionalized with a halomethyl group can be accomplished using methods such as that described by Lipshutz (Lipshutz et al., J. Am. Chem. Soc. 121: 11664-11673 (1999)), the disclosure of which is incorporated herein by reference. In addition, the synthesis of substituted methylene aromatic moieties, such as phenols, can be accomplished using methods described by U.S. Pat. No. 6,545,184 to Lipshutz et al., U.S. Patent Application Publication No. 2005/0137410 to Lipshutz et al. and U.S. Patent Application Publication No. 2005/0148675 to Lipshutz et al. the disclosures of which are also herein incorporated by reference.

Synthesis of the Carbometalated Species

In a first aspect the present invention provides a method of carbometallating an alkyne substrate, forming a carbometallated species, wherein an alkyl moiety is bound to a metal. The carbometallation reaction proceeds with at least 90% regioselectivity, with respect to the attachment point of the metal.

In one embodiment, the present invention provides a method of carboaluminating an alkyne substrate, forming a vinylalane. The method comprises: (a) contacting the alkyne substrate and Al(L)ₚ₊₁ and an alkylaluminoxane, preferably iso-butylaluminoxane (IBAO), in the presence of a carboalumination catalyst and a solvent. Each ligand L is independently selected from substituted or unsubstituted alkyl, substituted or unsubstituted alkoxy, substituted or unsubstituted aryl and substituted or unsubstituted aryloxy. The integer p is a member selected from 1 and 2. In a preferred embodiment at least one of the ligands L is methyl. In a particularly preferred embodiment, Al(L)ₚ₊₁ is (Me)₃Al. The alkyne is preferably a terminal alkyne. More preferably the alkyne is a member selected from the compounds having a structure according to Formula VII: 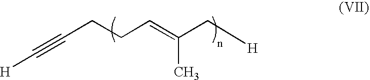
wherein n is an integer from 0 to 19.

Thus, in a preferred embodiment, the carboalumination reaction produces a vinylalane as the sole or major regioisomer that has a structure according to Formula (XIII):

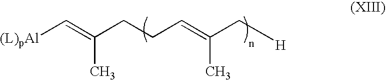

Optionally water and/or an alcohol R²⁰OH is added to the reaction mixture, wherein R²⁰ is a branched or unbranched alkyl radical with 1 to 15 carbon atoms, which can be optionally substituted with 1 to 5 hydroxy substituents. Preferred alcohols R²⁰OH include methanol, ethanol, propanol, isopropanol, n-butanol, sec-butanol, tert-butanol and the like.

Regioselectivity

The carboalumination methods of the invention may result in the formation of regioisomers, in which the aluminum is attached to different carbon atoms of the original alkyne bond. The formation of different regioisomers during carboalumination leads to the formation of isomeric products in subsequent coupling reactions. The factors influencing the regioselectivity of the carboalumination are well known to those skilled in the art. Those include for example the temperature, the nature of the solvent and of the carboalumination catalyst. However, known methods have not lead to satisfactory regioselectivity when using common and inexpensive catalysts.

Using the methods of the invention, the carboalumination reaction typically proceeds with high regioselectivity toward the carboaluminated product, in which the aluminum is attached to the terminal carbon atom of the substrate, when the substrate is a terminal alkyne (see Scheme 1 in Example 1). In one exemplary embodiment, the regioselectivity is between about 90% and about 100%, preferably between about 95% and about 100% and more preferably between about 97% and about 100%.

Carboalumination Catalyst

A variety of carboalumination catalysts can be used in the methods of the invention. Those include those described in U.S. patent application Ser. No. 11/304,023 filed Dec. 15, 2005, which is incorporated herein in its entirety. In an exemplary embodiment, the carboalumination catalyst is selected from zirconium (Zr), titanium (Ti) and hafnium (Hf) species. Numerous metal-based catalysts, such as titanocenes and zirconocenes, are of use as carboalumination catalysts in the invention. An advantage of the current invention is that the carboalumination reaction can be carried out with high regioselectivity and high yields using common and inexpensive catalysts. In a preferred embodiment, the carboalumination catalyst is Cp₂ZrCl₂.

The carboalumination catalyst can be present in the reaction mixture in any useful amount. In one exemplary embodiment, the carboalumination catalyst is present in amounts of less than 1 equivalent, preferably less than 0.5 molar equivalents, preferably less than 0.4 molar equivalents, preferably less than 0.3 molar equivalents, preferably less than 0.25 molar equivalents, preferably less than 0.2 molar equivalents, preferably less than 0.15 molar equivalents, more preferably less than 0.1 molar equivalents (10 mol-%) relative to the alkyne substrate. In another exemplary embodiment, the carboalumination catalyst is used in an amount of less than 0.08 molar equivalents, preferably less than 0.06 molar equivalents, preferably less than 0.05 molar equivalents (5 mol-%), and more preferably less than 0.03 molar equivalents, and more preferably less than 0.01 molar equivalents relative to the alkyne substrate. In another exemplary embodiment, the carboalumination catalyst is used in an amount of less than 0.05 molar equivalents relative to the alkyne substrate.

In this embodiment, the invention is based on recognition that the remaining organometallic carboalumination catalyst (e.g., the zirconium salts), rather than the potential organic impurities, is problematic in the coupling of a carboaluminated alkyne described herein, and a methylene moiety described herein (such as for example, Figures IV, V, VI, VIa, VIa) to form a product described herein, and that minimization of the carboalumination catalyst allows for a shortened (“one pot”) route to the target ubiquinone analog. Thus, when a minimized amount of a zirconium or titanium species is used (e.g. ≦10 mol-% or less than 5 mol-%), the carboaluminated product does not have to be separated from the metal salts derived from the catalyst prior to its being used in a coupling reaction with a methylene moiety. Thus, in one embodiment, the coupling reaction (e.g., between the product of a carboalumination reaction and a molecule according to Formula (IV)) is conducted essentially without prior isolation of the vinylalane that has formed during the carboalumination reaction. Surprisingly, no marked degradation in the purity or quantity of the coupling product results from omitting the purification step.

The aluminum present in the carboaluminated species, can be formally neutral (an alane) or it can be charged (an aluminate). The transition metal chemistry can be catalytic or stoichiometric. For example, the alkyne substrate can be aluminated by catalytic carboalumination, forming an adduct used directly in the synthesis of a ubiquinone or, alternatively, the metalated species is transmetalated to a different reagent.

In an exemplary embodiment, the carboalumination catalyst has a structure according to the following formula: 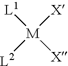
wherein M is a member selected from zirconium, titanium and hafnium. L¹ and L² are members independently selected from substituted or unsubstituted aryl, substituted or unsubstituted heteroaryl and substituted or unsubstituted cycloalkyl. L¹ and L² can optionally be covalently connected through a bridging ligand, Z. This method also has the proviso that L¹ and L² cannot both be unsubstituted cyclopentadienyl and L¹ and L² are not covalently connected to form substituted or unsubstituted tetraphenylporphyrinyl. In an exemplary embodiment, L¹ and L² are not covalently connected to form substituted or unsubstituted phenylporphyrinyl. In an exemplary embodiment, L¹ and L² are not covalently connected to form substituted or unsubstituted porphyrinyl. X′ and X″ are members independently selected from hydrogen, substituted or unsubstituted alkyl, a leaving group and an empty coordination site on M. The p in (L)ₚ₊₁Al is an integer between 1 and 2. Each L in (L)ₚ₊₁Al is a member independently selected from substituted or unsubstituted alkyl, substituted or unsubstituted alkoxy, substituted or unsubstituted aryl and substituted or unsubstituted aryloxy, thus forming said first vinyl alane. In an exemplary embodiment, each L in (L)ₚ₊₁Al is a member independently selected from substituted or unsubstituted C₁ to C₁₀ alkyl, substituted or unsubstituted C₁ to C₁₀ alkoxy, substituted or unsubstituted C₁ to C₁₀ aryl and substituted or unsubstituted C₁ to C₁₀ aryloxy.

A variety of carboalumination catalysts can be used in this invention. In an exemplary embodiment, the carboalumination catalyst has a structure which is a member selected from Formula (XLIII) and Formula (XLIV): 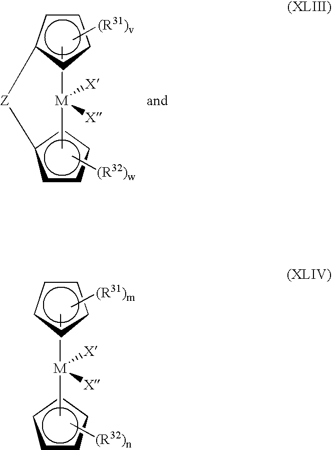
wherein M is a member selected from zirconium, titanium and hafnium. X and X are members independently selected from hydrogen and a leaving group, wherein said leaving group is a member selected from halogen, OR³⁶, OC(O)R³⁶, OS(O)R³⁶, OSO₂R³⁶, SR³⁶, S⁺(R³⁶)₂, OP(O)R³⁶R³⁷, P(O)N(R³⁶)₂(R³⁶)₂, P⁺(R³⁶)₃, P(O)R³⁸R³⁶R³⁹R³⁶. R³⁶ and R³⁷ are members independently selected from substituted or unsubstituted alkyl, substituted or unsubstituted aryl, substituted or unsubstituted heteroaryl and substituted or unsubstituted heterocycloalkyl and R³⁸ and R³⁹ are members independently selected from S and O. The indices v and w are integers independently selected from 0 to 4. When v is greater than 1, then two or more of R³¹, taken together with the carbons to which they are attached, optionally form a ring. When w is greater than 1, then two or more R³², taken together with the carbons to which they are attached, optionally form a ring. The index m is an integer selected from 0 to 5 and the index n is an integer selected from 0 to 5, with the proviso that at least one of m and n is not 0. When m is greater than 1, then two or more of R³¹, taken together with the carbons to which they are attached, optionally form a ring and when n is greater than 1, then two or more of R³², taken together with the carbons to which they are attached, optionally form a ring. R³¹ and R³² are members independently selected from substituted or unsubstituted alkyl, substituted or unsubstituted cycloalkyl, substituted or unsubstituted heteroalkyl, substituted or unsubstituted heterocycloalkyl, substituted or unsubstituted aryl, substituted or unsubstituted heteroaryl, OR²⁶, NR²⁶R²⁷ and —SiR²⁶R²⁷R²⁸. R²⁶, R²⁷ and R²⁸ are members independently selected from substituted or unsubstituted alkyl, substituted or unsubstituted cycloalkyl, substituted or unsubstituted heteroalkyl, substituted or unsubstituted heterocycloalkyl, substituted or unsubstituted aryl and substituted or unsubstituted heteroaryl. Z is a member selected from substituted or unsubstituted alkyl, substituted or unsubstituted cycloalkyl, substituted or unsubstituted heteroalkyl, substituted or unsubstituted heterocycloalkyl, substituted or unsubstituted aryl, substituted or unsubstituted heteroaryl and —SiR^{29a}R^{29b}. R^{29a} and R^{29b} are members independently selected from substituted or unsubstituted alkyl, substituted or unsubstituted cycloalkyl, substituted or unsubstituted heteroalkyl, substituted or unsubstituted heterocycloalkyl, substituted or unsubstituted aryl, substituted or unsubstituted heteroaryl, —OR^{26a}, —SR^{26a}, —NR^{26a}R^{26b} and —PR^{26a}R^{26b}. R^{26a} and R^{26b} are members independently selected from substituted or unsubstituted alkyl, substituted or unsubstituted cycloalkyl, substituted or unsubstituted heteroalkyl, substituted or unsubstituted heterocycloalkyl, substituted or unsubstituted aryl and substituted or unsubstituted heteroaryl.

In an exemplary embodiment, R²⁸ and R²⁹ are independently selected from hydrogen, substituted or unsubstituted C₁ to C₁₂ alkyl, substituted or unsubstituted C₁ to C₁₂ heteroalkyl, substituted or unsubstituted C₁ to C₁₂ cycloalkyl, substituted or unsubstituted C₁ to C₁₂ heterocycloalkyl, substituted or unsubstituted C₃ to C₁₀ aryl, substituted or unsubstituted C₃ to C₁₀ heteroaryl, substituted or unsubstituted C₇ to C₁₂ arylalkyl, substituted or unsubstituted C₃ to C₁₂ heteroarylalkyl, substituted or unsubstituted C₁ to C₁₂ cycloalkyl-alkyl, and substituted or unsubstituted C₁ to C₁₂ heterocycloalkyl-alkyl. R^{26a} and R^{26b} are members independently selected from substituted or unsubstituted C₁ to C₆₀ alkyl, substituted or unsubstituted C₁ to C₆₀ cycloalkyl, substituted or unsubstituted C₁ to C₆₀ heteroalkyl, substituted or unsubstituted C₁ to C₆₀ heterocycloalkyl, substituted or unsubstituted C₃ to C₂₀ aryl and substituted or unsubstituted C₃ to C₂₀ heteroaryl. In another exemplary embodiment, Z is a member selected from substituted or unsubstituted C₁ to C₁₀ alkyl, substituted or unsubstituted C₁ to C₁₀ cycloalkyl, substituted or unsubstituted C₁ to C₁₀ heteroalkyl, substituted or unsubstituted C₁ to C₁₀ heterocycloalkyl, substituted or unsubstituted C₃ to C₂₀ aryl, substituted or unsubstituted C₃ to C₂₀ heteroaryl and —SiR^{29a}R^{29b}. In another exemplary embodiment, each R³¹ and R³² is a member independently selected from substituted or unsubstituted C₁ to C₆₀ alkyl, substituted or unsubstituted C₁ to C₆₀ cycloalkyl, substituted or unsubstituted C₁ to C₆₀ heteroalkyl, substituted or unsubstituted C₁ to C₆₀ heterocycloalkyl, substituted or unsubstituted C₃ to C₂₀ aryl, substituted or unsubstituted C₃ to C₂₀ heteroaryl, OR²⁶, NR²⁶R²⁷ and —SiR²⁶R²⁷R²⁸. R²⁶, R²⁷ and R²⁸ are members independently selected from substituted or unsubstituted C₁ to C₆₀ alkyl, substituted or unsubstituted C₁ to C₆₀ cycloalkyl, substituted or unsubstituted C₁ to C₆₀ heteroalkyl, substituted or unsubstituted C₁ to C₆₀ heterocycloalkyl, substituted or unsubstituted C₃ to C₂₀ aryl, substituted or unsubstituted C₃ to C₂₀ heteroaryl.

In an exemplary embodiment, the indices m and n are integers independently selected from 1 to 5 and R³¹ and R³² are members independently selected from substituted or unsubstituted alkyl. In another exemplary embodiment, R³¹ and R³² are members independently selected from substituted or unsubstituted C₁ to C₁₀ alkyl. Z is a member selected from —(CH₂)ᵣ—, —(CH)₂—, —Si(R²⁸R²⁹)—, —SiMe₂-, —Si(CH(Me)₂)₂-, —Si(R²⁸C(Me)₃)-, —Si(Ph)₂-, —CH₂OSi(Me₂)OCH₂—, —C(R²⁸R²⁹)ᵣ, —CH₂C(R²⁸R²⁹)CH₂— and —C(R²⁸R²⁹)ᵣ—CH₂C(R²⁸R²⁹)CH₂—, in which the index r is an integer selected from 1 to 8. R²⁸ and R²⁹ are independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, substituted or unsubstituted heteroaryl, substituted or unsubstituted arylalkyl, substituted or unsubstituted heteroarylalkyl, substituted or unsubstituted cycloalkyl-alkyl, and substituted or unsubstituted heterocycloalkyl-alkyl. In another exemplary embodiment, R²⁸ and R²⁹ are independently selected from hydrogen, substituted or unsubstituted C₁ to C₁₂ alkyl, substituted or unsubstituted C₁ to C₁₂ heteroalkyl, substituted or unsubstituted C₁ to C₁₂ cycloalkyl, substituted or unsubstituted C₁ to C₁₂ heterocycloalkyl, substituted or unsubstituted C₃ to C₁₀ aryl, substituted or unsubstituted C₃ to C₁₀ heteroaryl, substituted or unsubstituted C₇ to C₁₂ arylalkyl, substituted or unsubstituted C₃ to C₁₂ heteroarylalkyl, substituted or unsubstituted C₁ to C₁₂ cycloalkyl-alkyl, and substituted or unsubstituted C₁ to C₁₂ heterocycloalkyl-alkyl. In another exemplary embodiment, Z is a member selected from ethylene, ethenylene and dimethylsilanylene.

In another exemplary embodiment, M is zirconium. In another exemplary embodiment, X and X are leaving groups, and each leaving group is independently selected from tosylate, mesylate, brosylate, nosylate, triflate, nonaflate, tresylate, —NR^{29d}R^{29e}, endocyclic nitrogen containing heteroaryl, F, Cl, Br and I in which R^{29d} and R^{29e} are members independently selected from substituted and unsubstituted alkyl and substituted and unsubstituted heteroalkyl.

In another exemplary embodiment, the carboalumination catalyst has a structure which is a member selected from:

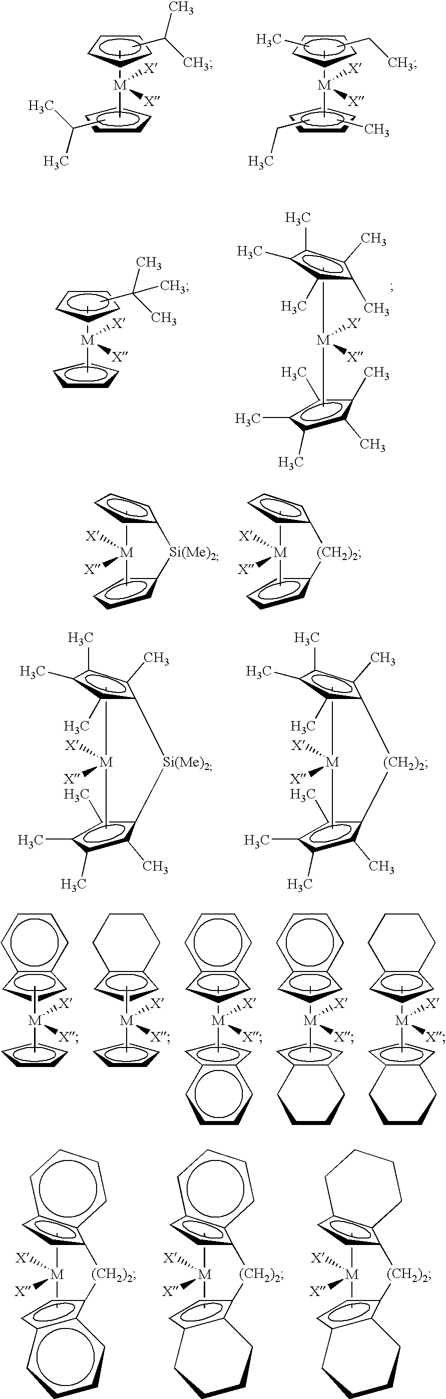

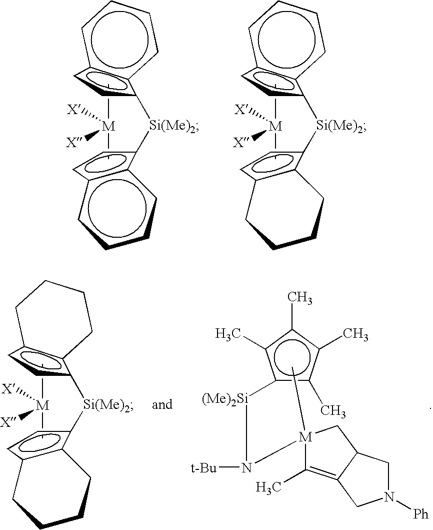

In an exemplary embodiment, wherein L¹ and L² are independently selected from substituted or unsubstituted cyclopentadienyl. In another exemplary embodiment, wherein R²³, R²⁴ and R²⁵ are methyl. In yet another exemplary embodiment, R²² is a member selected from hydrogen and —SiR²⁶R²⁷R²⁸. In still another exemplary embodiment, R²² is hydrogen.

In an exemplary embodiment, the carboalumination catalyst is a member selected from dimethyl zirconocene dimethyl; tetra-neopentyl-zirconium-(IV); tris-neopentylzirconium-(IV)-chloride; tetrakis(dimethylamino)zirconium; bis-benzyl-zirconium-(IV)-dichloride; tetra-benzyl-zirconium-(IV); tetra-chloro-bis(tetrahydrofuran) zirconium(IV); cyclopentadienylzirconium trichloride; pentamethylcyclopentadienyl zirconium trichloride; (R)-biphenyl-(3,4-dimethyl-1-cyclopenta-dienyl)-zirconium(IV)-(R)-(1,1′binaphthyl-2); (S)-biphenyl-(3,4-dimethyl-1-cyclopenta-dienyl)-zirconium(IV)-(R)-(1,1′binaphthyl-2); isopropylidenebis(cyclopentadienyl) zirconium dichloride; bis-(methylcyclopentadienyl)dichloro-zirconium(IV); bis-(1,3-dimethylcyclopentadienyl)-zirconium(IV)-dichloride; bis(tetramethylcyclopentadienyl)zirconium dichloride; bis(pentamethylcyclopentadienyl)zirconium dimethyl; bis(pentamethylcyclopentadienyl)zirconium dichloride; bis(ethylcyclopentadienyl)zirconium dichloride; bis(1-ethyl-3-methylcyclopentadienyl)zirconium dichloride; bis(n-propylcyclopentadienyl)zirconium dichloride; bis(isopropylcyclopentadienyl)zirconium dichloride; isopropylidenebis (cyclopentadienyl)zirconium dichloride; bis(butylcyclopentadienyl)difluorozirconium(IV); bis(n-butylcyclopentadienyl)zirconium dichloride; bis(t-butylcyclopentadienyl)zirconium dimethyl; bis(t-butylcyclopentadienyl)zirconium dichloride; dimethylbis(t-butylcyclopenta dienyl)zirconium dichloride; bis-(butylcyclopenta-dienyl)-difluoro-zirconium(IV); bis(iso-butylcyclopentadienyl)zirconium dichloride; bis(n-pentylcyclopentadienyl)zirconium dichloride; bis(n-octylcyclo-pentadienyl)zirconium dichloride; bis(n-dodecylcyclopenta dienyl)zirconium dichloride; bis(trimethylsilylcyclopentadienyl)zirconium (IV) dichloride; bis[(trimethylsilyl)cyclopentadienyl]zirconium dichloride; [dimethylbis (cyclopentadienyl)silyl]zirconium dichloride; bis(cyclopentadienyl)-zirconium(IV)-(tert-butylsulfonate)-(hydride); bis(cyclopentadienyl)zirconium(IV)-(hydrido)(triflate); (cyclopentadienyl)(pentamethyl cyclopentadienyl)zirconium dichloride; (n-propylcyclopentadienyl)(tetramethylcyclopentadienyl)zirconium dichloride; (pentamethylcyclopentadienyl)(n-propylcyclopentadienyl)zirconium dichloride; cyclopentadienyl(1,3-dimethylcyclopentadienyl)zirconium dichloride; dimethylsilylbis(3-n-propylcyclopentadien-1-yl)zirconium dichloride; dimethylsilylbis-(cyclopentadienyl)dichloro-zirconium-(IV); rac-dimethylsilyl bis-(4-tert-butyl-2-methyl-cyclopentadienyl)-dichloro-zirconium-(IV); rac-dimethylsilylbis-(4-tert-butyl-2-methyl-cyclopentadienyl)-zirconium-(IV)-dimethyl; rac-dimethylsilylbis-(4-tert-butyl-2-methylcyclopentadienyl)dichlorozirconium(IV); rac-dimethylsilylbis-(4-tert-butyl-2-methylcyclopentadienyl)zirconium (IV) dimethyl; (cyclopentadienyl)(indenyl)zirconium dichloride; bis(indenyl)zirconium dichloride; dimethylbis(indenyl) zirconium; bis(2-methylindenyl)zirconium dichloride; dimethylbis(indenyl)zirconium dichloride; rac-dimethylsilylbis-(1-indenyl)zirconium (IV) dimethyl; rac-dimethylsilylbis(1-indenyl)zirconium dichloride; meso-dimethylsilylenebis(2-methyl-1-indenyl)zirconium (IV) dichloride; rac-dimethylsilylenebis(4,5,6,7-tetrahydro-1-indenyl)zirconium (IV) dichloride; rac-dimethylsilylbis-(4,5,6,7-tetrahydro-1-indenyl)zirconium (IV) dichloride; rac-dimethylsilylbis-(4,5,6,7-tetrahydro-1-indenyl)-zirconium-(IV)-dimethyl; rac-dimethylsilylbis-(4,5,6,7-tetrahydro-1-indenyl)-zirconium(IV)-(1,1′binaphthyl-2); dimethylsilylbis-(4,5,6,7-tetrahydro-1-indenyl)-zirconium(IV)-(R)-(1,1′binaphthyl-2); rac-ethylenebis(1-indenyl)dimethylzirconium(IV); rac-ethylenebis(indenyl)zirconium (IV) dichloride; meso-ethylenebis(1-indenyl)zirconium (IV) dichloride; rac-1,2-ethylenebis(2-methyl-1-indenyl)zirconium(IV)dichloride; rac-ethylenebis-(4,5,6,7-tetrahydro-1-indenyl)-difluorozirconium (IV); rac-ethylenebis(4,5,6,7-tetrahydro-1-indenyl)zirconium dichloride; rac-ethylenebis-(4,5,6,7-tetrahydro-1-indenyl)-difluoro-zirconium(IV); rac-ethylenebis-(4,5,6,7-tetrahydro-1-indenyl)-dimethyl-zirconium(IV); rac-ethylenebis(4,5,6,7-tetrahydro-1-indenyl)zirconium dichloride; rac-ethylenebis-(4,5,6,7-tetrahydro-1-indenyl)-zirconium(IV)-(1,1′binaphthyl-2); (R,R)-ethylenebis-(4,5,6,7-tetrahydro-1-indenyl)-dimethylzirconium (IV); (R,R)-ethylenebis-(4,5,6,7-tetrahydro-1-indenyl-indenyl)-dimethyl-zirconium(IV); (S,S)-ethylenebis (4,5,6,7-tetrahydro-1-indenyl-dimethyl)zirconium(IV); (R,R)-ethylenebis-(4,5,6,7-tetrahydro-1-indenyl)-zirconium(IV)-(R)-(1,1′binaphthyl-2); (S,S)-ethylenebis-(4,5,6,7-tetrahydro-1-indenyl)-zirconium(IV)-(S)-(1,1′binaphthyl-2); dichloroethylenebis(indenyl)zirconium(IV); rac-dichloro-ethylenebis-(4,5,6,7-tetrahydro-1-indenyl)-zirconium(IV); dichloro-(R,R)-ethylenebis-(4,5,6,7-tetra-hydro-1-indenyl)-zirconium(IV); dichloro-(S,S)-ethylenebis-(4,5,6,7-tetra-hydro-1-indenyl)-zirconium(IV) 1,2-ethylenebis(9-fluorenyl)zirconium dichloride; [1-(9-fluorenyl)-2-(5,6-cyclopenta-2-methyl-1-indenyl)-ethane]zirconium dichloride; isopropylidene(cyclopentadienyl)(9-fluorenyl)zirconium(IV)dichloride; isopropylidene(3-methylcyclopentadienyl)(9-fluorenyl)zirconium(IV)dichloride; diphenylmethylidene(cyclopentadienyl)(2,7-di-tert-butylfluoren-9-yl)zirconium dichloride; diphenylmethylidene(cyclopentadienyl)(9-fluorenyl)zirconium dichloride; diphenylmethylene(cyclopentadienyl)(9-fluorenyl)zirconium dichloride; and [1-(9-fluorenyl)-2-(5,6-cyclopenta-2-methyl-1-indenyl)ethane]zirconium dichloride. In another exemplary embodiment, a titanium or halfnium atom is substituted for the zirconium atom in this list of carboalumination catalysts.

In another exemplary embodiment, L¹ and L² of the carboalumination catalyst primarily interact with M through pi bonding. In another exemplary embodiment, the interactions between L¹ and M, and L² and M, are between the M and carbon atoms on L¹ and L². In another exemplary embodiment, L¹ and L² are substituted or unsubstituted aryl and are covalently connected through a bridging ligand which comprises a silicon atom. In another exemplary embodiment, L¹ is substituted or unsubstituted aryl, L² is substituted or unsubstituted cycloalkyl, and L¹ and L² are covalently connected through a bridging ligand which comprises a silicon atom. In yet another exemplary embodiment, L¹ and L² are substituted or unsubstituted heteroaryl and are covalently connected through a bridging ligand which comprises a silicon atom. In still another exemplary embodiment, L¹ is substituted or unsubstituted heteroaryl, L² is substituted or unsubstituted cycloalkyl, and L¹ and L are covalently connected through a bridging ligand which comprises a silicon atom. In still another exemplary embodiment, L¹ is substituted or unsubstituted heteroaryl, L² is substituted or unsubstituted aryl, and L¹ and L² are covalently connected through a bridging ligand which comprises a silicon atom.

In another exemplary embodiment, L¹ and L² are substituted or unsubstituted aryl and are covalently connected through a bridging ligand which comprises substituted or unsubstituted alkyl and does not comprise a silicon atom. In another exemplary embodiment, L¹ is substituted or unsubstituted aryl, L² is substituted or unsubstituted cycloalkyl, and L¹ and L² are covalently connected through a bridging ligand which comprises substituted or unsubstituted alkyl and does not comprise a silicon atom. In yet another exemplary embodiment, L¹ and L² are substituted or unsubstituted heteroaryl and are covalently connected through a bridging ligand which comprises substituted or unsubstituted alkyl and does not comprise a silicon atom. In still another exemplary embodiment, L¹ is substituted or unsubstituted heteroaryl, L² is substituted or unsubstituted cycloalkyl, and L¹ and L are covalently connected through a bridging ligand which comprises substituted or unsubstituted alkyl and does not comprise a silicon atom. In still another exemplary embodiment, L¹ is substituted or unsubstituted heteroaryl, L² is substituted or unsubstituted aryl, and L¹ and L² are covalently connected through a bridging ligand which comprises substituted or unsubstituted alkyl and does not comprise a silicon atom.

Additive

The additive in the invention is a member selected from a substituted or unsubstituted alkylaluminoxane, substituted or unsubstituted primary or secondary alkyl alcohols and substituted or unsubstituted primary or secondary alkyl thiols. In an exemplary embodiment, the additive is a substituted or unsubstituted alkylaluminoxane, with the proviso that the alkylaluminoxane is not methylaluminoxane. In an exemplary embodiment, the additive is a substituted or unsubstituted primary or secondary alkyl alcohol, with the proviso that the alcohol is not methanol. In another exemplary embodiment, the alcohol is not methanol, phenol, or t-butanol. In an exemplary embodiment, the additive is present in an amount of about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49 and 0.5 molar equivalents. In an exemplary embodiment, the additive amount is preferably from about 0.01 to about 0.3 molar equivalents relative to the alkyne substrate, preferably from about 0.01 to about 0.3 molar equivalents relative to the alkyne substrate. In an exemplary embodiment, the additive amount is preferably from about 0.05 to about 0.25 molar equivalents relative to the alkyne substrate. In an exemplary embodiment, the additive amount is preferably from about 0.15 to about 0.4 molar equivalents relative to the alkyne substrate. In an exemplary embodiment, the additive amount is preferably from about 0.01 to about 0.3 molar equivalents relative to the alkyne substrate

Alkylaluminoxane

Any alkylaluminoxane (alkyl aluminum oxides) can be used in the methods of the invention, e.g. those of the general formula: [—Al(R^{a})O—]ₙ), wherein R^{a} is C₁-C₁₀ alkyl. Preferred are those alkylaluminoxanes wherein the alkyl residues are other than methyl. Unexpectedly, the inventors have found that the replacement of methylaluminoxane (MAO) with iso-butylaluminoxane (IBAO) as the additive significantly improves the regioselectivity of the carboalumination reaction in favor of the desired terminal alane. This unexpected observation suggests a steric effect and a significant involvement of the aluminoxane in the reaction mechanism. Other alkylaluminoxanes, such as ethyl-, n-propyl-, iso-propyl-, n-butyl- and alkylaluminoxanes with even larger alkyl groups are also useful in the methods of the invention. Iso-butylaluminoxane (IBAO) is currently preferred.

In an exemplary embodiment, the alkylaluminoxane (e.g., IBAO) is used in an amount less than 1 equivalent, relative to the alkyne substrate. In another exemplary embodiment, the alkylaluminoxane is used from about 0.01 to about 0.5 molar equivalents, preferably from about 0.01 to about 0.3 molar equivalents relative to the alkyne substrate.

Alkyl Alcohols

Any alkyl alcohol can be used in the methods of the invention. Preferred are primary and secondary alcohols. In an exemplary embodiment, the alkyl alcohol is a member selected from primary and secondary alcohols, with the proviso that said substituted or unsubstituted primary or secondary alkyl alcohol is not methanol. In an exemplary embodiment, the alkyl alcohol is a member selected from primary and secondary alcohols, with the proviso that said substituted or unsubstituted primary or secondary alkyl alcohol is not substituted or unsubstituted methanol, substituted or unsubstituted phenol or substituted or unsubstituted t-butanol. In an exemplary embodiment, the substituted or unsubstituted primary or secondary alkyl alcohol is a member selected from substituted or unsubstituted butanol, substituted or unsubstituted isobutanol, substituted or unsubstituted sec-butanol, substituted or unsubstituted ethanol, substituted or unsubstituted propanol, substituted or unsubstituted isopropanol, substituted or unsubstituted pentanol, substituted or unsubstituted isopentanol, substituted or unsubstituted neopentanol, substituted or unsubstituted hexanol, substituted or unsubstituted isohexanol, and substituted or unsubstituted neohexanol. In an exemplary embodiment, the alkyl alcohol is substituted or unsubstituted isobutanol. In an exemplary embodiment, the alkyl alcohol is isobutanol.

Alkyl Thiols

Any alkyl thiol can be used in the methods of the invention. Preferred are primary and secondary thiols. In an exemplary embodiment, the alkyl thiol is a member selected from primary and secondary thiols, with the proviso that said substituted or unsubstituted primary or secondary alkyl thiol is not methylthiol. In an exemplary embodiment, the alkyl thiol is a member selected from primary and secondary thiols, with the proviso that said substituted or unsubstituted primary or secondary alkyl thiol is not substituted or unsubstituted methylthiol, substituted or unsubstituted phenylthiol or substituted or unsubstituted t-butylthiol. In an exemplary embodiment, the substituted or unsubstituted primary or secondary alkyl alcohol is a member selected from substituted or unsubstituted butylthiol, substituted or unsubstituted isobutylthiol, substituted or unsubstituted sec-butylthiol, substituted or unsubstituted ethylthiol, substituted or unsubstituted propylthiol, substituted or unsubstituted isopropylthiol, substituted or unsubstituted pentylthiol, substituted or unsubstituted isopentylthiol, substituted or unsubstituted neopentylthiol, substituted or unsubstituted hexylthiol, substituted or unsubstituted isohexylthiol, and substituted or unsubstituted neohexylthiol. In an exemplary embodiment, the alkyl alcohol is substituted or unsubstituted isobutylthiol. In an exemplary embodiment, the alkyl alcohol is isobutylthiol.

Reaction Conditions

The order of addition of reactants for carrying out the method of carboalumination according to the present invention can be varied. In an exemplary embodiment, the carboalumination catalyst and metal compound (L)ₚ₊₁M are contacted first and the alkyne substrate is subsequently added, followed by water, an alcohol (R²⁰OH) or the alkylaluminoxane (e.g., IBAO). In an exemplary embodiment, the carboalumination catalyst and alkyne substrate are contacted first and the metal compound added subsequently, followed by IBAO. In an exemplary embodiment, the alkyne substrate and metal compound are contacted first and the carboalumination catalyst subsequently added, followed by IBAO. In another exemplary embodiment, the metal compound and IBAO are added together and the alkyne substrate added subsequently, followed by the carboalumination catalyst.

The present invention can be conducted under a variety of conditions. For example, the carboalumination reaction can be conducted at a temperature from about −40° C. to about 50° C. In an exemplary embodiment, the temperature of the carboalumination reaction can be at about room temperature. In another exemplary embodiment, the temperature of the carboalumination reaction can be from about −20° C. to about 20° C. In another exemplary embodiment, the temperature of the carboalumination reaction can be from about −10° C. to about 12° C.

The length of time for the carboalumination reaction can vary from 30 minutes to 100 hours. In general, the lower the temperature at which the reaction is conducted, the longer is the amount of time for the reaction to go to completion. For example, when the temperature is at −15° C., the reaction can be completed from about 10 hours to about 15 hours.

Solvent

The carboalumination reaction can be performed in any solvent or solvent mixture. In an exemplary embodiment, the carboalumination can be in a solvent mixture of chlorinated and non-chlorinated solvents. In another exemplary embodiment, the carboaluminating occurs in a solvent which is a member selected from chlorobenzene, toluene, xylenes, mesitylene, dichloromethane (DCM), 1,2-dichloroethane (DCE), trifluoromethylbenzene, benzene and combinations thereof. In a preferred embodiment, the carboalumination reaction is performed in a mixture of dichloromethane and chlorobenzene, which optionally contains a non-chlorinated solvent, such as toluene. In an exemplary embodiment, the solvent or solvent mixture is aprotic.

Preparation of the Alkyne Substrate

In an exemplary embodiment, the alkyne substrate can be produced by (i) forming a propyne dianion by contacting propyne with a base; and (ii) combining said propyne dianion with a compound according to Formula (VIII): CH₃ (VIII) 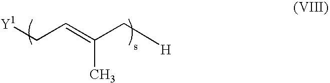
wherein s is an integer from 1 to 19 and Y′ is a leaving group, such as chlorine, bromine or iodine, or a sulfonic acid ester, e.g. tosylate or mesylate.

In another exemplary embodiment, the compound according to Formula (XI) 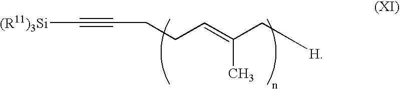
can be produced by a method comprising contacting a compound according to Formula (VIII) with an anion according to Formula (XII): 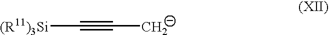
generated from (R¹¹)₃SiC≡C—CH₃ in the presence of a base.

Anion (XII) is formed in situ or, alternatively, it is formed prior to combining it with a compound according to Formula (VIII). The anion is formed with an appropriate base, e.g., an organolithium base.

The compound according to Formula (×1) is subsequently desilylated, e.g. using an appropriate desilylation agent such as aqueous base, alkoxides and the like, to produce a compound according to Formula (VII): 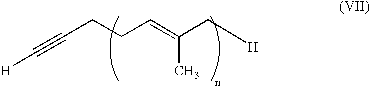
wherein n is an integer from 0 to 19. The compound of Formula (VII) can then be carboaluminated to produce a carboaluminated species, which can be used in subsequent coupling reactions.

In Formula (XII), groups represented by R¹¹ include H, substituted or unsubstituted alkyl, substituted or unsubstituted aryl, substituted or unsubstituted heteroalkyl, or a heteroatom bound to a group that satisfies the valency requirements of the heteroatom. Each R¹¹ group is selected independently of the others; they may or may not be the same as the other R¹¹ groups.

In another exemplary embodiment, the invention provides a method of carboaluminating an alkyne substrate having the formula (VII), which comprises (a) contacting a reaction mixture comprising an alkyne substrate with an adsorbent medium; and (b) eluting the alkyne substrate from said adsorbent medium and collecting said alkyne substrate as a single fraction; and (c) submitting the product from step (b) to a carboaluminating reaction essentially without further purification, thus carboaluminating said alkyne substrate.

In an exemplary embodiment, the alkyne substrate is prepared using a derivative of solanesol and a reagent that adds a propyne synthon, e.g., a silylated-propyne in metalated form, a propargyl Grignard reagent, or a dianion of propyne. The invention also provides a quick, efficient method of purifying an alkyne, such as those produced by the methods disclosed herein. The purification method includes dissolving the crude product from the reaction in an organic solvent, e.g., petroleum ether, and passing the resulting solution through a short column of an adsorbent material, such as a chromatographic medium, e.g., silica, alumina, and the like. The so purified alkyne substrate is sufficiently pure for use in the subsequent synthetic process, e.g. the said carboalumination, without a marked degradation in yield of, or quality of product produced by, the subsequent step.

In still a further exemplary embodiment, the invention provides a method of preparing the alkyne substrate according to Formula (VII). In this method, a propyne dianion is formed by contacting propyne with a base, e.g., n-butyllithium (n-BuLi), which is usually used in an amount of 2 to 15 equivalents. In an exemplary embodiment, the amount is of 2 to 8 equivalents, with respect to the propyne. The reaction is carried out at temperatures from −60 to 30° C. The dianion is then combined with a compound according to Formula (VIII).

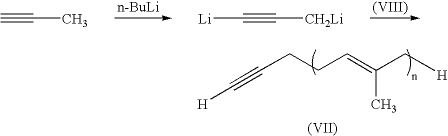

The method of the invention using propyne gas has several advantageous features. For example, propyne gas is less expensive than TMS-propyne. Moreover, use of propyne eliminates the necessity for a desilylation step, providing a two-step protocol from propyne to the solanesyl alkyne. The use of the dianion also reduces side products commonly produced from the use of the TMS-propyne mono-anion (XII).

The present method also provides an advanced approach for processing the alkyne substrate precursor to the CoQₙ₊₁ side-chain. The present method is analogous to the method of preparing the terminal alkyne set forth in U.S. Pat. No. 6,545,184. The method of the invention simplifies purification of the crude alkyne substrate (XIII) obtained, following standard workup, by filtration of the crude material through a small amount of a chromatographic medium, using an organic solvent of low polarity, e.g., petroleum ether, hexanes, etc., to elute the alkyne substrate from the medium. Importantly, the method obviates the need to fractionate the alkyne substrate, which elutes off the medium and is collected as a single fraction that contains essentially all of the small molecular organic species. An exemplary medium is a small plug of sand with an equal volume of adsorbent such as silica gel. Removal of the solvent leaves colorless to pale yellow material of ca. 70-80% purity that is ready to be used directly in the next step involving carboalumination. The purity of the material used to prepare the alkyne substrate is not critical and can be varied over a broad range of about 10-99% by weight. Material of lower purity will afford an alkyne substrate of lower purity. It was not recognized previously that use in a carboalumination of a crude alkyne substrate preparation, having only inorganics and highly polar organics removed, could provide material as pure and in as good of a yield as the use of a highly purified alkyne substrate, e.g., chromatographically purified. Alternatively, purified alkyne substrate can be used in the carboalumination.

Coupling of the Vinylalane to a Substituted Methylene Moiety

In one aspect, the method of the present invention is based on a retrosynthetic disconnection that relies on the well-known maintenance of olefin geometry in group 10 transition metal coupling reactions (Hegedus, TRANSITION METALS IN THE SYNTHESIS OF COMPLEX ORGANIC MOLECULES, University Science Books, Mill Valley, Calif., 1994). The discussion that follows focuses on a reaction, in which the coupling partners are a vinyl organometallic and a substituted-methylene moiety in which the methylene group is substituted with a leaving group (e.g., halomethyl quinone, ether, sulfonate, etc.). Please note that these reactions have similarities to coupling reactions between a vinylalane and a protected, substituted-methylene phenol, as described in U.S. Pat. No. 6,545,184, which is herein incorporated by reference. The focus of the discussion is for clarity of illustration, and other methods and coupling partners appropriate for use in those methods will be apparent to those of skill in the art and are within the scope of the present invention.

In an exemplary embodiment, the carboaluminated species generated by the methods of the invention are utilized in a coupling reaction to a substituted methylene moiety, such as a compound of Formula IV:

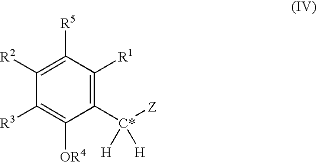

In Formula (IV) Z is a leaving group. In a preferred embodiment, Z is Cl. R¹, R², R³ and R⁵ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl, wherein R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl. At least two of R¹, R², R³ and R⁵, together with the carbon atoms to which they are attached, can optionally be joined to form a 5- to 7-membered ring. R⁴ is a protecting group.

In an exemplary embodiment, the product of the carboalumination reaction is contacted with a compound according to Formula (IV) in the presence of a coupling catalyst effective at catalyzing coupling between the C* atom according to Formula (IV) and the vinylalane, formed during the carboalumination step, thereby forming a compound according to Formula (I): 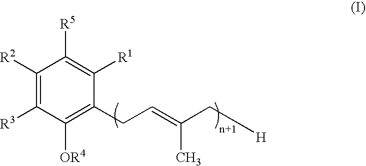
wherein n is an integer from 0 to 19 and R¹, R², R³ and R⁵ are as defined for Formula (IV).

In another exemplary embodiment, the carboaluminated species of the method are utilized in a coupling reaction to a compound of Formula (V):

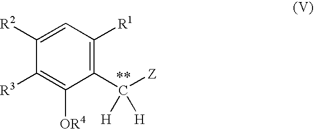

In Formula (V) Z is a leaving group. In a preferred embodiment, Z is Cl. R¹, R², R³ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl, wherein R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl. R² and R³, together with the carbon atoms to which they are attached, can optionally be joined to form a 5- to 7-membered ring. R⁴ is a protecting group.

The reaction partners are contacted in the presence of a coupling catalyst effective at catalyzing coupling between the C** atom according to Formula (V) and the vinylalane, thereby forming a compound according to Formula (II): 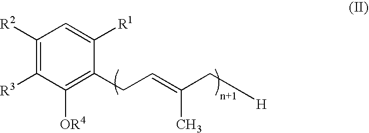
wherein n is an integer from 0 to 19 and R¹, R², R³ are as defined for Formula (V).

In another exemplary embodiment, the carboaluminated species is utilized in a coupling reaction to a compound of Formula (VI):

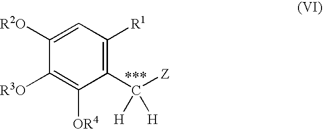

In Formula (VI) Z is a leaving group. In a preferred embodiment, Z is Cl. R¹ is a member selected from H and C₁-C₆ alkyl. R² and R³ are members independently selected from C₁-C₆ alkyl, and R⁴ is a protecting group.

The coupling partners are contacted in the presence of a coupling catalyst effective at catalyzing coupling between said C*** atom according to Formula (VI) and the vinylalane, thereby forming a compound according to Formula (III): 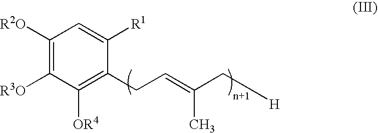
wherein n is an integer from 0 to 19 and R¹, R², R³ are as defined for Formula (VI).

In one exemplary embodiment, n is 9. In another exemplary embodiment, n is 9 and R¹ is methyl. In yet another exemplary embodiment, n is 9 and R¹, R² and R³ are each methyl. In a further exemplary embodiment, the leaving group R⁴ is a member selected from a tosylate and a mesylate.

Coupling Catalyst

In an exemplary embodiment, the coupling catalyst utilizes a species that comprises a transition metal. Exemplary transition metal species of use as coupling catalysts include, but are not limited to, those metals in Groups IX, X, and XI. Exemplary metals within those Groups include Cu(I), Pd(0), Co(0) and Ni(0). Recent reports have demonstrated that catalyst couplings, using the appropriate reaction partners and based on metal catalysis, are quite general and can be used to directly afford known precursors (Naruta, J. Org. Chem., 45:4097 (1980); Eren, et al., J. Am. Chem. Soc., 110:4356 (1988) and references therein; Van Lient et al., Rec. Trav. Chim. Pays-Bays 113:153 (1994); Rüttiman et al., Helv. Chim. Acta, 73:790 (1990); Terao et al., J. Chem. Soc., Perkin Trans. 1:1101 (1978), Lipshutz et al, J. Am. Chem. Soc. 121: 11664-11673 (1999); Lipshutz et al., J. Am. Chem. Soc. 118: 5512-5313 (1999)). In another exemplary embodiment, the metal is Ni(0).

The coupling catalyst can be formed by any of a variety of methods recognized in the art. In an exemplary embodiment in which the transition metal is Ni(0), the coupling catalyst is formed by contacting a Ni(II) compound with two equivalents of a reducing agent, reducing Ni(II) to Ni(0). In an exemplary embodiment, the Ni(II) compound is NiCl₂(PPh₃)₂. In yet another exemplary embodiment, the reducing agent in n-butyllithium. In yet another exemplary embodiment, the method of the invention comprises contacting NiCl₂(PPh₃)₂, or a similar Ni species, with about two equivalents of a reducing agent (e.g., n-butyllithium), thereby reducing said NiCl₂(PPh₃)₂ to Ni(0). Alternatively, other readily available forms of Ni(0) can be employed (e.g., Ni(COD)₂).

The coupling catalyst can be a homogeneous or heterogeneous catalyst (Cornils B, Herrmann W A, APPLIED HOMOGENEOUS CATALYSIS WITH ORGANOMETALLIC COMPOUNDS: A COMPREHENSIVE HANDBOOK IN TWO VOLUMES, John Wiley and Sons, 1996; Clark J H, CATALYSIS OF ORGANIC REACTIONS BY SUPPORTED INORGANIC REAGENTS, VCH Publishers, 1994; Stiles A B, CATALYST SUPPORTS AND SUPPORTED CATALYSTS: THEORETICAL AND APPLIED CONCEPTS, Butterworth-Heinemann, 1987). In one exemplary embodiment, the coupling catalyst is supported on a solid material (e.g., charcoal, silica, etc.). In another exemplary embodiment, the coupling catalyst is a supported nickel catalyst (see, e.g., Lipshutz et al., Synthesis, 2110 (2002); Lipshutz et al., Tetrahedron 56:2139-2144 (2000); Lipshutz and Blomgren, J. Am. Chem. Soc. 121: 5819-5820 (1999); and Lipshutz et al., Inorganica Chimica Acta 296: 164-169 (1999).

The method of the invention is practiced with any useful amount of coupling catalyst effective at catalyzing coupling between the methylene carbon atom on the aromatic group or of the methylene moiety, and the vinylic carbon attached to Al of the vinylalane. In one exemplary embodiment, the coupling catalyst is present in an amount from about 0.1 mole % to about 10 mole %. In another exemplary embodiment, the coupling catalyst is present in an amount from about 0.5 mole % to about 5 mole %, preferably in an amount from about 2 mole % to about 5 mole %.

Coupling Conditions

The above mentioned coupling reaction can be carried out in all solvents known to those of skill in the art, suitable as solvents for transition metal catalyzed coupling reactions, e.g. ethers e.g. THF, diethyl ether and dioxane, amines e.g. triethylamine, pyridine and NMI, and others e.g. acetonitrile, acetone, ethyl acetate, DMA, DMSO, NMP and DMF. In a preferred embodiment, it is not required to completely remove the solvent in which the carboalumination was carried out, prior to the coupling. Currently preferred is THF.

The conditions of the coupling reaction can be varied. For example, the order of addition of reactants can be varied. In an exemplary embodiment, the substituted methylene moiety and carboaluminated species are contacted, and then the coupling catalyst is subsequently added. In an exemplary embodiment, the substituted methylene moiety and coupling catalyst are contacted, and then the carboaluminated species is subsequently added. In an exemplary embodiment, the coupling catalyst and carboaluminated species are contacted, and then the substituted methylene moiety is subsequently added.

The amount of the substituted methylene moiety relative to the alkyne employed in the prior carboalumination can also be varied. In an exemplary embodiment, the substituted methylene moiety, can be reacted in amounts ranging from 0.9 to 10 equivalents relative to the alkyne. In another exemplary embodiment, the substituted methylene moiety can be reacted in amounts ranging from 0.9 to 5 equivalents, preferably from 0.9 to 2, and most preferably from 1.1 to 1.6 equivalents, relative to the alkyne.

The coupling reaction of the present invention can be conducted under a variety of conditions. For example, the coupling reaction can be conducted at a temperature from −40° C. to 50° C. In an exemplary embodiment, the temperature of the coupling reaction can be room temperature. In another exemplary embodiment, the temperature of the carboalumination reaction can be from −30° C. to 0° C. In another exemplary embodiment, the temperature of the carboalumination reaction can be from about −25° C. to about −15° C.

The length of time for the coupling reaction can vary from 10 minutes to 10 hours. In general, the lower the temperature is at which the reaction is conducted, the longer the amount of time for the reaction to go to completion. When the temperature is about 0° C., the reaction can be completed from about 30 minutes to about 3 hours.

Further Processing After Coupling

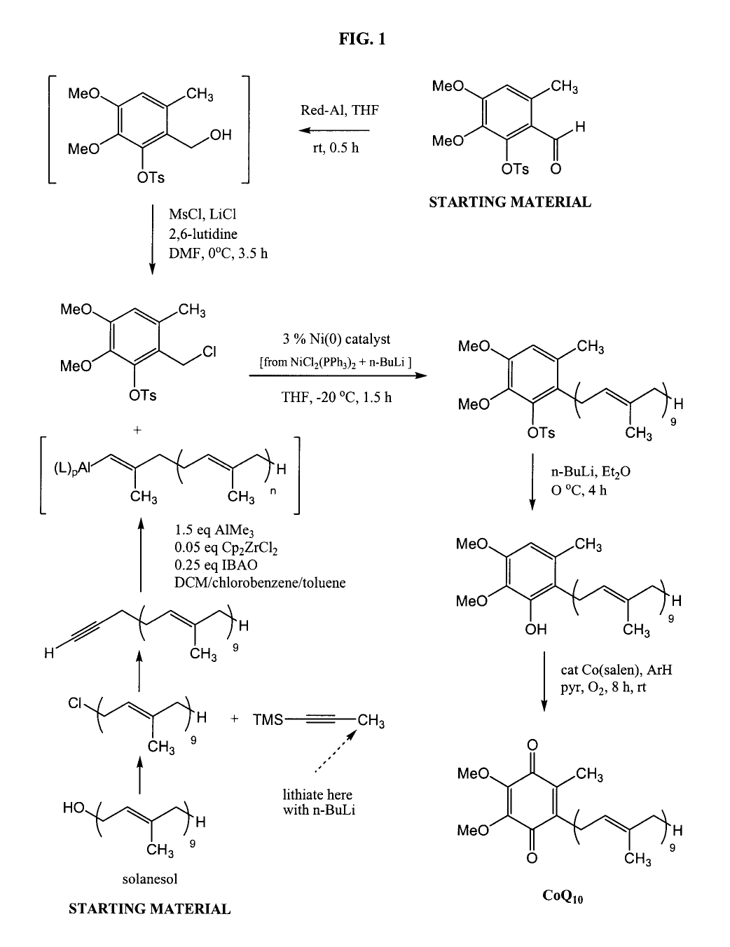

After coupling of the vinylalane to the substituted methylene moiety (e.g., of Formula IV), the product (e.g., a molecule of Formula III) can be further processed to generate a ubiquinol or a ubiquinone, such as CoQ₁₀. Typically, the synthesis of a ubiquinone involves removal of the protecting group R⁴ to generate the unprotected phenol, followed by oxidation of the phenol to the corresponding quinone as outlined in FIG. 1.

Removal of the Protecting Group

In an exemplary embodiment, the coupling product, e.g., compounds according to Formulae (I), (II) and (III), are further processed to remove the protecting group R⁴ generating a phenolic product. Methods for the removal of protecting groups are known in the art (see, for example, Greene et al., PROTECTIVE GROUPS IN ORGANIC SYNTHESIS, 3rd ed., John Wiley & Sons, New York, 1999.

In one exemplary embodiment, removal of R⁴ from a molecule according to Formula (III) affords a compound according to Formula (IX):

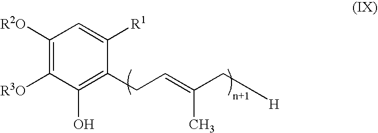

In an exemplary embodiment, n in Formula (IX) is 9. As described above the carboalumination methods of the invention typically proceed with high regioselectivity producing essentially one regioisomer (e.g., 95% regioselectivity). In turn, less unwanted product is formed during subsequent coupling reactions. As a result, it may not be necessary to purify the product of the coupling reaction prior to subsequent synthetic steps, allowing for a “one-pot” reaction sequence. Thus, in one exemplary embodiment, the coupling products according to Formulae (I), (II) or (III) are subjected to a chemical reaction essentially without prior purification. In another exemplary embodiment, a compound according to Formula (IX) is generated from a compound according to Formula (III) without purifying the compound of Formula (III) after coupling reaction and prior to removal of the protecting group.

Oxidation of the Phenol to the Quinone

The substituted methylene moiety synthesized by the method of the invention is generally oxidized to the corresponding quinone, if the moiety was not already a quinone. The phenol can be oxidized directly to the quinone or, alternatively, it can first be converted to the corresponding hydroquinone and oxidized to the quinone. An array of reagents and reaction conditions are known that oxidize phenols to quinones, see, for example, Trost B M et al. COMPREHENSIVE ORGANIC SYNTHESIS: OXIDATION, Pergamon Press, 1992.

In an exemplary embodiment, a compound according to Formula (IX) is contacted with an oxidant thereby producing a compound according to Formula (X):

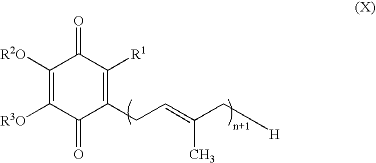

In an exemplary embodiment, the oxidant comprises a transition metal chelate. The chelate is preferably present in the reaction mixture in an amount from about 0.1 mole % to about 10 mole %. In another exemplary embodiment, the transition metal chelate is used in conjunction with an organic base, such as an amine. Exemplary amines are the trialkyl amines, such as triethylamine. In another exemplary embodiment, the transition metal chelate is Co(salen). The chelate can be a heterogeneous or homogeneous oxidant. In an exemplary embodiment, the chelate is a supported reagent.

Alternate synthetic routes for use converting the compounds of the invention to ubiquinones, and methods to prepare useful intermediates, are provided in U.S. Pat. No. 6,545,184 to Lipshutz et al., the disclosure of which is herein incorporated by reference.

The materials, methods and devices of the present invention are further illustrated by the examples that follow. These examples are offered to illustrate, but not to limit the claimed invention.

### EXAMPLES

### General

In the examples below, unless otherwise stated, temperatures are given in degrees Celsius (° C.); operations were carried out at room or ambient temperature, “rt,” or “RT,” (typically a range of from about 18-25° C.; evaporation of solvent was carried out using a rotary evaporator under reduced pressure (typically, 4.5-30 mm Hg) with a bath temperature of up to 60° C.; the course of reactions was typically followed by thin layer chromatography (TLC) and reaction times are provided for illustration only; melting points are uncorrected; products exhibited satisfactory ¹H-NMR and/or microanalytical data; yields are provided for illustration only; and the following conventional abbreviations are also used: mp (melting point), L (liter(s)), mL (milliliters), mmol (millimoles), g (grams), mg (milligrams), min (minutes), h (hours), RBF (round bottom flask).

The following chemicals were subjected to the following preparatory steps prior to use in the Examples. PCl₃ was refluxed for 3 h at 76° C. while slowly purging with dry argon to expel HCl, distilled at atmospheric pressure and stored in a sealed container under argon until needed. DMF, 2-propanol and benzene were used as supplied from Fisher chemicals. Solanesol, purified by column chromatography on SiO₂ with 10% diethyl ether/petroleum ether, was dried azeotropically with toluene or benzene immediately prior to use. THF was distilled from Na/benzophenone ketyl prior to use. n-BuLi was obtained as a 2.5 M solution in hexanes from Aldrich and standardized by titration immediately prior to use. Ethanol was 200 proof, dehydrated, U.S.P. Punctilious grade. All other reagents were purchased from suppliers and used without further purification.

Reactions were performed in oven-dried glassware under an argon atmosphere with Teflon coated stir bars and dry septa. All commercially available reagents were distilled either from CaH₂ or molecular sieves under an inert atmosphere before use. 2.0 M Trimethylaluminum (in toluene), 4.33 M Trimethylaluminum (in chlorobenzene), Triisobutyldialuminoxane (10 wt. % in toluene), and bis(cyclopentadienyl)zirconium dichloride were purchased from Aldrich. 2-Methyl-1-propanol was purchased from Acros. GC analyses were performed using an HP-5-capillary column (0.25 μm×30 m; cross-linked 5% PH ME siloxane) and a time program with 5 min at 50° C. followed by 20° C./min ramp to 280° C., and 20 min holding at this temp. Products were confirmed by ¹H NMR, ¹³C NMR, IR, LREIMS and HR-EI or HR-CI Mass Spectrometry. TLC and chromatographic solvents are abbreviated as follows: EA: ethyl acetate; PE: petroleum ether; DCM: dichloromethane. Column chromatography was performed on a Biotage SP4 version 2.0 using KP-SIL 60A silica gel. TLC analysis was performed on commercial Kieselgel 60 F₂₅₄ silica gel plates. NMR spectra were obtained on Varian Inova systems using CDCl₃ as the solvent with proton and carbon resonance at 400 MHz and 100 MHz, respectively. Mass spectral data were acquired on a VF Autospec or an analytical VG-70-250 HF instrument.

### Example 1

### 1.1 Carboalumination of the Alkyne of Formula (VII) wherein n=9

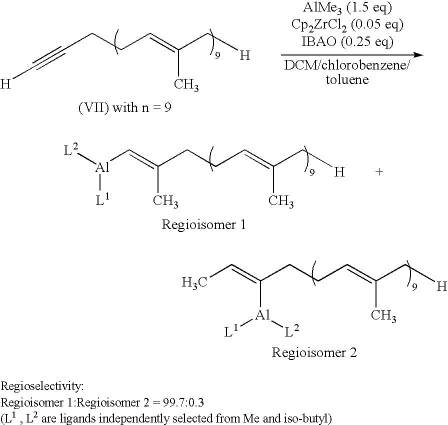

To a dry, argon purged 25 mL round bottom flask was added Cp₂ZrCl₂ (0.0146 g, 0.05 mmol). The flask was then sealed under argon. IBAO (25% w/w solution in toluene, 0.69 mL, 0.25 mmol) was added to the flask and the solvent was removed in vacuo. Dichloromethane (0.69 mL) and chlorobenzene (0.66 mL) were then added followed by the dropwise addition of Me₃Al (4.33 M in dichorobenzene; 0.76 mL, 1.5 mmol). The reaction mixture stirred for 15 min at rt and was then cooled to −15° C. Solanesol alkyne (0.769 g @ 85% purity=0.654 g pure alkyne, 1.0 mmol, at rt) was then added dropwise to the reaction flask at −15° C. After 14 h, the solution turned a bright amber-yellow color and the alkyne was entirely consumed according to TLC (product R_{f}=0.78, 25% EtOAc:hexanes). The solvent was removed in vacuo and the flask was cooled to −20° C.

### 1.2 Coupling to Afford CoQ₁₀

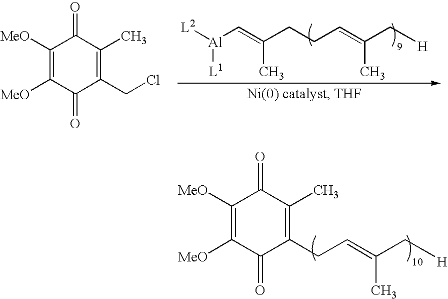

In a separate flask, dimethoxy-methyl-chloroquinone (DMMCQ, 254 mg, 1.10 mmol) was dissolved in THF (1.5 mL), cooled to 0° C., and added to the flask containing the vinylalane (step 1.1 above). In another flask, n-BuLi (2.7 M solution, 30 μL, 0.08 mmol) was added to a solution of NiCl₂(PPh₃)₂ (0.027 g, 0.04 mmol) in THF (1.0 mL), and the initially gray, heterogeneous solution of Ni(II) turned red-black as it was reduced to Ni(0). This was immediately transferred to the flask containing the vinylalane. The coupling was allowed to stir at −20° C. for 1.5 h without exposure to light, then diluted with ether (10 mL) and 1M HCl (20 drops). The organic layer was separated and the aqueous portion was washed ether (3×10 mL). The combined organic extracts were dried over anhydrous MgSO₄ and the solvent removed under reduced pressure. Purification using flash column chromatography on silica gel in a gradient solvent system starting with 98% hexanes and ending with 20% hexanes:ethyl acetate afforded the pure CoQ₁₀ as an orange oil (0.773 g, 90%). (R_{f}=0.39, 25% EtOAc:hexanes).

The regioselectivity (desired regio-isomer:side product) of the carboalumination reaction was determined by NMR (99.73:0.27) and HPLC (99.74:0.26). It was determined using the ratio of products formed during the coupling reaction of step 1.2.

### Example 2

### 2.1 Standard Carboalumination of Alkynes Using Catalytic Cp₂ZrCl₂/Catalytic IBAO/Excess Me₃Al

To a flame dried argon purged 25 mL round bottomed (rb) flask was added bis(cyclopentadienyl)zirconium dichloride (14.6 mg, 0.050 mmol, 5.0 mol %), followed by the dropwise addition at 0° C. of Me₃Al (2.0 M solution in toluene, 0.75 mL, 1.50 mmol, 1.5 equiv). While stirring at 0° C., IBAO (0.28 mL, 0.100 mmol, 10 mol %) was then added. Lastly, the alkyne (1.00 mmol) was introduced and the homogeneous pale yellow solution stirred at rt until TLC analysis (5% CH₂Cl₂/pet ether) indicated that the carboalumination was complete.

### 2.2 Coupling to Afford CoQ₁₀

To a flame-dried argon purged 25 mL round-bottom flask was added zirconocene (14.6 mg, 0.05 mmol, 5.0 mol %) and IBAO (10% w/w solution in toluene, 0.69 mL, 0.25 mmol, 25 mol %). The solvent was removed in vacuo and replaced with dry CH₂Cl₂ (0.66 mL). The flask was cooled to 0° C. and Me₃Al (4.33 M solution in chlorobenzene, 0.35 ml, 1.5 mmol, 1.5 equiv) followed by solanesol-derived alkyne, n=9 (654.0 mg, 1.0 mmol) were added to the reaction mixture. The flask was then cooled −15° C. and the reaction was allowed to proceed for 14 h, at which point TLC analysis (5% CH₂Cl₂/pet. ether) indicated the reaction was complete. The solvent was completely removed in vacuo and replaced with dry THF (1.0 mL), and the reaction was cooled to −20° C. in preparation for the coupling. Chloromethylated quinone (254 mg, 1.10 mmol, 1.1 equiv) was dissolved in THF (0.75 mL) and transferred via cannula to the vinylalane solution. In a separate flask n-BuLi (24 μL, 2.5 M solution, 0.06 mmol) was added to a solution of NiCl₂(PPh₃)₂ (19.63 mg, 0.03 mmol, 3.0 mol %) in THF (0.50 mL), and the active Ni(0) catalyst was immediately transferred to the vinylalane solution. After 2 h at −20° C. the reaction was diluted with Et₂O and quenched into 0.10 M aqueous HCl. The mixture was extracted with Et₂O (3×10 mL) and the combined extracts dried over anhydrous MgSO₄. Filtration and evaporation led to crude material that was purified by column chromatography (10% EtOAc/pet. ether) to afford 769.5 mg CoQ₁₀ (89%). Spectral data matched that previously reported, Lipshutz, et al. J. Am. Chem. Soc. 124: 14282 (2002). R_{f}=0.39 (3:1 Hex/EtOAc); Regioselectivity: 99.85/0.15 (HPLC), 99.76/0.24 (NMR).

### 2.3 Coupling to Afford (E)-(3-Bromo-2-methylallyl)cyclopentane

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), IBAO (10% w/w solution in toluene, 0.28 mL, 0.100 mmol, 10 mol %) and 3-cyclopentyl-1-propyne (0.132 mL, 1.00 mmol). The reaction was allowed to proceed for 2 h, at which point TLC analysis (5% CH₂Cl₂/pet. ether) indicated the carboalumination was complete. The solvent was completely removed in vacuo and replaced with dry THF (2.5 mL). In a separate flame dried argon purged 10 mL rb flask was added N-bromosuccinimide (214 mg, 1.20 mmol, 1.2 equiv) and THF (2.5 mL). This solution was added dropwise via canula to the reaction. After 1 h at rt, the reaction was diluted with pet ether (10 mL). The organic phase was washed with water and brine (2×10 mL) and dried over anhydrous MgSO₄. The solvent was removed in vacuo and the residue purified by silica gel chromatography (5% CH₂Cl₂/pet. ether), isolating a colorless oil, 185 mg (91%). R_{f}=0.72 (5% CH₂Cl₂/pet. ether). ¹H NMR (400 MHz, CDCl₃) δ 5.85 (s, 1H), 2.10 (m, 2H), 2.03 (m, 1H), 1.78 (s, 3H), 1.72 (m, 2H), 1.58 (m, 4H), 1.28 (b, 1H), 1.10 (m, 1H); ¹³C NMR (100 MHz, CDCl₃) δ 142.0, 101.3, 44.8, 37.8, 32.5, 25.2, 19.3; HREIMS m/z calcd for C₉H₁₅Br 202.0357; found 202.0360. Regioselectivity: 99.8:0.2 (GC).

### 2.4 Coupling to afford (E)-Ethyl 7-chloro-3-methylhept-2-enoate

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), IBAO (10% w/w solution in toluene, 0.28 mL, 0.100 mmol, 10 mol %) and 6-chloro-1-hexyne (0.121 mL, 1.0 mmol). The reaction was allowed to proceed for 3 h. The reaction was allowed to proceed for 3 h after which it was cooled to 0° C. and ethyl chloroformate (0.29 mL, 3.0 mmol, 3.0 equiv) was added dropwise. After 1 h, the reaction was diluted with petroleum ether (10 mL) and quenched with 1 M HCl (ca. 1 mL, caution should be exercised when quenching Me₃Al directly into water!). The aqueous layer was extracted with EtOAc (3×10 mL), and the combined organic extracts were washed with brine and dried over anhydrous MgSO₄. The solvent was removed in vacuo and the crude product was purified by silica gel chromatography (3:1 Hex/EtOAc) isolating 173 mg of the title compound as a colorless oil (85%). R_{f}=0.56 (3:1 Hex/EtOAc); ¹H NMR (CDCl₃, 400 MHz) δ 5.65 (s, 1H), 4.14 (q, J=7.2 Hz, 2H), 3.54 (t, J=6.5 Hz, 2H), 2.16 (m, 5H), 1.76 (m, 2H), 1.64 (m, 2H), 1.27 (t, J=7.0 Hz, 3H); ¹³C NMR (CDCl₃, 100 MHz) δ 166.9, 159.2, 116.1, 59.7, 44.9, 40.1, 32.0, 24.6, 18.8, 14.5; HREIMS m/z calcd for C₁₀H₁₇ClO₂ 204.0917; found 204.0916. Regioselectivity: >99:1 (other isomer not detected by GC).

### 2.5 Coupling to afford ((E)-1-(7-Chloro-3-methylhept-2-enyl)-4-fluorobenzene

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), IBAO (10% w/w solution in toluene, 0.28 mL, 0.100 mmol, 10 mol %) and 6-chloro-1-hexyne (0.121 mL, 1.0 mmol). The reaction was allowed to proceed for 3 h. The solvent was completely removed under reduced pressure and replaced with THF (1.0 mL). 4-Fluorobenzyl chloride (0.125 mL, 1.05 mmol, 1.05 equiv) was dissolved in THF (0.50 mL) and transferred via cannula to the reaction. In a separate flask n-BuLi (24 μL, 2.5 M solution, 0.06 mmol) was added to a solution of NiCl₂(PPh₃)₂ (19.63 mg, 0.03 mmol, 3.0 mol %) in THF (0.50 mL), and the dark red-brown Ni(0) catalyst was immediately transferred to the vinylalane solution at rt. After 3 h, TLC analysis indicated complete disappearance of the vinylalane. The reaction was diluted with EtOAc (10 mL) and quenched with 1 M aqueous HCl (ca. 1 mL). The aqueous layer was extracted with EtOAc (3×10 mL), and the combined organic extracts were washed with brine and dried over anhydrous MgSO₄. The solvent was removed in vacuo and the crude product was purified by silica gel chromatography (5% CH₂Cl₂/pet. ether), giving 215 mg of the title compound as a colorless oil (89%). R_{f}=0.26 (5% CH₂Cl₂/pet. ether); ¹H NMR (CDCl₃, 400 MHz) δ 7.10 (m, 2H), 6.95 (m, 2H), 5.31 (m, 1H), 3.55 (t, J=7.0 Hz, 2H), 3.32 (d, J=7 Hz, 2H), 2.08 (t, J=7.0 Hz, 2H), 1.75 (m, 2H), 1.70 (s, 3H), 1.55 (m, 2H); ¹³C NMR (CDCl₃, 100 MHz) δ 162.6, 137.3, 136.0, 129.8, 123.6, 115.3, 115.1, 45.2, 38.9, 33.5, 32.3, 25.2, 16.1; HREIMS m/z calcd for C₁₄H₁₈ClF 240.1081; found 240.1086. Regioselectivity: 99.93:0.07 (GC).

### Example 3

### 3.1 Standard Carboalumination of Alkynes Using Catalytic Cp₂ZrCl₂/Catalytic Isobutanol/Excess Me₃Al

To a flame dried argon purged 25 mL round bottomed (rb) flask was added bis(cyclopentadienyl)zirconium dichloride (14.6 mg, 0.050 mmol, 5.0 mol %), followed by the dropwise addition at 0° C. of Me₃Al (2.0 M solution in toluene, 0.75 mL, 1.50 mmol, 1.5 equiv). While stirring at 0° C., isobutanol (9.25 μL, 0.100 mmol, 10 mol %) was then added. Lastly, the alkyne (1.00 mmol) was introduced and the homogeneous pale yellow solution stirred at rt until TLC analysis (5% CH₂Cl₂/pet ether) indicated that the carboalumination was complete.

### 3.2 Coupling to Afford CoQ₁₀

Using the standard procedure outlined above, the following amounts of reagents were used: zirconocene (14.6 mg, 0.05 mmol, 5.0 mol %), CH₂Cl₂ (1.0 mL), Me₃Al (2.0 M solution in toluene, 0.75 mL, 1.5 mmol, 1.5 equiv), isobutanol (23.2 μL, 0.25 mmol, 25 mol %) and solanesol-derived alkyne, n=9 (654.0 mg, 1.0 mmol). Alkyne, n=9, must be filtered prior to use as a solution in 5% DCM/pet. ether through basic alumina to obtain a colorless viscous oil. The reaction was allowed to proceed for 8 h, at which point TLC analysis (5% CH₂Cl₂/pet. ether) indicated the reaction was complete. The solvent was completely removed in vacuo and replaced with dry THF (1.0 mL), and the reaction was cooled to 0° C. in preparation for the coupling. Chloromethylated quinone (254 mg, 1.10 mmol, 1.1 equiv) was dissolved in THF (1.0 mL) and transferred via cannula to the vinylalane solution. In a separate flask n-BuLi (24 μL, 2.5 M solution, 0.06 mmol) was added to a solution of NiCl₂(PPh₃)₂ (19.63 mg, 0.03 mmol, 3.0 mol %) in THF (0.50 mL), and the active Ni(0) catalyst was immediately transferred to the vinylalane solution. After 1.5 h at 0° C. the reaction was diluted with Et₂O and quenched into 0.10 M aqueous HCl. The mixture was extracted with Et₂O (3×10 mL) and the combined extracts dried over anhydrous MgSO₄. Filtration and evaporation led to crude material that was purified by column chromatography (10% EtOAc/pet. ether) to afford 682 mg CoQ₁₀ (79%). Regioselectivity: 99.70/0.30 (HPLC). Spectral data matched that previously reported, Lipshutz, et al. J. Am. Chem. Soc. 124: 14282 (2002).

### 3.3 Coupling to afford ((E)-3-(2-phenylprop-1-enyl)cyclohexanone

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), isobutanol (9.25 μL, 0.100 mmol, 5 mol %), and phenylacetylene (0.110 mL, 1.0 mmol). The reaction was allowed to proceed for 4 h. In a separate flame dried argon purged 25 mL rb flask was added Et₂O (4 mL) and CuCN. LiCl (0.10 mL, 1.0 M solution in THF, 0.10 mmol, 10 mol %) and the reaction was cooled to 0° C. 2-Cyclohexen-1-one (107 μL, 1.1 mmol) was dissolved in Et₂O (1.0 mL) and added to the reaction. The vinylalane solution was then added in a dropwise manner at 0° C. over the course of 1 h. The reaction mixture was then diluted with Et₂O (10 mL) and quenched with 1 M HCl (ca. 1 mL). The aqueous layer was extracted with Et₂O (3×10 mL), and the combined organic extracts were washed with brine and dried over anhydrous MgSO₄. The solvent was removed in vacuo and the crude product was purified by silica gel chromatography (3:1 hex/EtOAc), isolating 173 mg of the title compound as a colorless oil (81%). R_{f}=0.38 (3:1 Hex/EtOAc); ¹H NMR (CDCl₃, 400 MHz) δ 7.38 (m, 2H), 7.32 (m, 2H), 7.23 (m, 1H), 5.62 (m, 1H), 2.88 (m, 1H), 2.28 (b, 4H), 2.04 (s, 3H), 1.80 (b, 2H), 1.56 (s, 2H); ¹³C NMR (CDCl₃, 100 MHz) δ211.4, 143.4, 135.2, 131.0, 128.4, 127.1, 125.9, 47.9, 41.4, 38.9, 31.7, 25.5, 16.2; HREIMS calcd for C₁₅H₁₈O 214.1358; found 214.1353. Regioselectivity: >99:1 (other isomer not detected by GC).

### 3.4 Coupling to afford (E)-2-Cyclohexyl-1-deuteriopropene

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), isobutanol (9.25 μL, 0.100 mmol, 10 mol %), and cyclohexylacetylene (0.11 mL, 1.0 mmol). The reaction was allowed to proceed for 4 h, and then quenched with D₂O (20 mL) and diluted with petroleum ether (20 mL). The aqueous phase was extracted with petroleum ether (2×10 mL) and the combined organic extracts were dried over anhydrous Na₂SO₄ and concentrated in vacuo. R_{f}=0.31 (5% CH₂Cl₂/pet. ether); 89% conversion (GC). Regioselectivity: 99.3:0.7 (GC).

### 3.5 Coupling to afford ((E)-1-(2-Cyclohexylprop-1-enyl)-anisole

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), isobutanol (9.25 μL, 0.100 mmol, 10 mol %), and cyclohexylacetylene (0.130 mL, 1.0 mmol). The reaction was allowed to proceed for 4 h. The solvent was completely removed under reduced pressure and replaced with THF (1.0 mL). 4-Iodoanisole (257 mg, 1.1 mmol, 1.1 equiv) was dissolved in THF (0.50 mL) and transferred via cannula to the reaction. In a separate flask n-BuLi (24 μL, 2.5 M solution, 0.06 mmol) was added to a solution of NiCl₂(PPh₃)₂ (19.6 mg, 0.03 mmol, 3.0 mol %) in THF (0.50 mL), and the active Ni(0) catalyst was immediately transferred to the vinylalane solution at rt. After 3 h, TLC analysis indicated complete disappearance of the vinylalane. The reaction was diluted with EtOAc (10 mL) and quenched with 1 M aqueous HCl (ca. 1 mL). The aqueous layer was extracted with EtOAc (3×10 mL), and the combined organic extracts were washed with brine and dried over anhydrous MgSO₄. The solvent was removed in vacuo and the crude product was purified by silica gel chromatography (3:1 Hex/EtOAc), to afford 195 mg of the title compound as a colorless oil (85%). R_{f}=0.63 (3:1 Hex/EtOAc); ¹H NMR (CDCl₃, 400 MHz) δ 7.19 (d, J=8.0 Hz, 2H), 6.82 (d, J=8.0 Hz, 2H), 6.20 (s, 1H), 3.82 (s, 3H), 2.00 (m, 1H), 1.83 (s, 3H), 1.80 (m, 3H), 1.75 (m, 1H), 1.30 (m, 6H); ¹³C NMR (CDCl₃, 100 MHz) δ 157.7, 143.0, 131.7 130.2, 122.5, 113.5, 55.4, 48.4, 32.1, 26.9, 26.6, 16.3; HREIMS m/z calcd for C₁₆H₂₂O 230.1671; found 230.1679. Regioselectivity: 99.77:0.23 (GC).

### Example 4

### ((E)-1-(2-Cyclohexylprop-1-enyl)-anisole (Methanol)

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), methanol (4 μL, 0.100 mmol, 10 mol %), and cyclohexylacetylene (0.130 mL, 1.0 mmol). The reaction was allowed to stir overnight. The solvent was completely removed under reduced pressure and replaced with THF (1.0 mL). 4-Iodoanisole (257 mg, 1.1 mmol, 1.1 equiv) was dissolved in THF (0.50 mL) and transferred via canula to the reaction. In a separate flask n-BuLi (24 μL, 2.5 M solution, 0.06 mmol) was added to a solution of NiCl₂(PPh₃)₂ (19.6 mg, 0.03 mmol, 3.0 mol %) in THF (0.50 mL), and the active Ni(0) catalyst was immediately transferred to the vinylalane solution at rt. A conversion of 15% by GC was observed for the coupling step after 3 h of stirring.

### Example 5

### ((E)-1-(2-Cyclohexylprop-1-enyl)-anisole (Phenol)

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), phenol (8.8 μL, 0.100 mmol, 10 mol %), and cyclohexylacetylene (0.130 mL, 1.0 mmol). The reaction was allowed to stir overnight. The carboalumination was unable to achieve a conversion higher than 40% by GC.

### Example 6

### ((E)-1-(2-Cyclohexylprop-1-enyl)-anisole (tert-butylalcohol)

Using the standard procedure outlined above, the following amounts of reagents were used: zirconocene (14.6 mg, 0.050 mmol, 5.0 mol %), Me₃Al (2.0 M solution in toluene, 0.75 mL, 1.50 mmol, 1.5 equiv), t-butanol (9.3 μL, 0.100 mmol, 10 mol %), and cyclohexylacetylene (0.130 mL, 1.0 mmol). The reaction was allowed to stir overnight. The carboalumination was unable to achieve a conversion higher than 80% by GC.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes.

What is claimed is:

1. A method of carboaluminating an alkyne substrate, forming a vinylalane with at least 90% regioselectivity, said method comprising:
(a) contacting said alkyne substrate and Al(L)ₚ₊₁ and an additive which is a member selected from substituted or unsubstituted alkylaluminoxane, substituted or unsubstituted primary or secondary alkyl alcohols and substituted or unsubstituted primary or secondary alkyl thiols, in the presence of a carboalumination catalyst and a solvent,
wherein
each L is independently selected from substituted or unsubstituted alkyl, substituted or unsubstituted alkoxy, substituted or unsubstituted alkylthio, substituted or unsubstituted aryl, substituted or unsubstituted aryloxy and substituted or unsubstituted arylthio; and
p is a member selected from 1 and 2.

2. The method of claim 1, with the proviso that at least one of said L is a member selected from substituted or unsubstituted alkyl and substituted or unsubstituted aryl.

3. The method of claim 1, with the proviso that at least one of said L is methyl.

4. The method of claim 1, wherein said additive is a member selected from isobutylaluminoxane and isobutanol.

5. The method of claim 1 wherein said regioselectivity is a member selected from at least 95%, at least 98% and at least 99%.

6. The method of claim 1, wherein said alkyne substrate is a terminal alkyne.

7. The method of claim 6, wherein said alkyne substrate has a formula which is a member selected from: 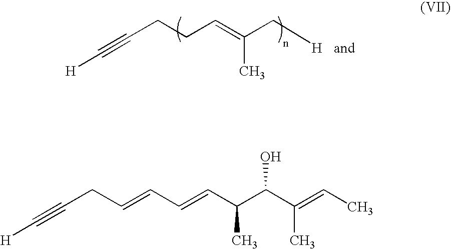
wherein n is an integer from 0 to 19.

8. The method of claim 1, wherein said additive is used in an amount from about 0.01 to about 0.5 molar equivalents relative to said alkyne substrate.

9. The method of claim 1, wherein said carboalumination catalyst is used in an amount of less than 0.1 molar equivalents relative to said alkyne substrate.

10. The method of claim 1, wherein said carboalumination catalyst is a member selected from zirconium-, titanium- and hafnium-containing species.

11. The method of claim 10, wherein said carboalumination catalyst is Cp₂ZrCl₂.

12. The method of claim 1, wherein said solvent is a member selected from dichloroethane (DCE), dichloromethane (DCM), chlorobenzene, a non-chlorinated solvent and mixtures thereof.

13. The method of claim 12, wherein said non-chlorinated solvent is a member selected from trifluoromethylbenzene and toluene.

14. The method of claim 1, further comprising:
(b) prior to step (a), contacting said Al(L)ₚ₊₁ and said additive in the presence of a carboalumination catalyst and a solvent.

15. The method of claim 14, wherein said contacting occurs for at least about 10 minutes.

16. The method of claim 1, further comprising:
(c) contacting the product of step (a) with a compound of Formula: 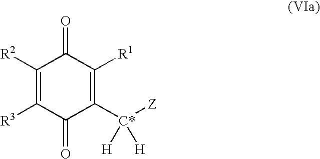
wherein
Z is a leaving group;
R¹, R² and R³ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl;
wherein
R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl; and
at least two of R¹, R² and R³, together with the carbon atoms to which they are attached, are optionally joined to form a 5- to 7-membered ring; and
in the presence of a coupling catalyst effective at catalyzing coupling between said C* atom according to Formula (IV) and said vinylalane of step (a), thereby forming a compound according to Formula (I):

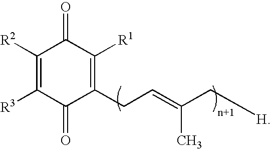

17. The method of claim 16, wherein R¹ is methyl; R² and R³ are methoxy and n is 9.

18. The method of claim 16, wherein R¹ is H; R² and R³ are methyl and n is a member selected from about 5 to about 8.

19. The method of claim 1, further comprising:
(c) contacting the product of step (a) with a compound which has a structure according to Formula: 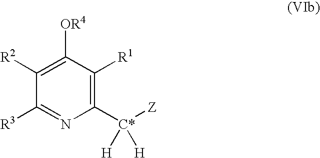
wherein
R¹, R² and R³ are members independently selected from H, OR⁸, halogen, CN, substituted or unsubstituted alkyl, substituted or unsubstituted heteroalkyl, substituted or unsubstituted aryl, substituted or unsubstituted heteroaryl and substituted or unsubstituted heterocycloalkyl;
wherein
R⁸ is a member selected from H, substituted or unsubstituted alkyl, substituted or unsubstituted heteroalkyl, substituted or unsubstituted aryl, substituted or unsubstituted heteroaryl and substituted or unsubstituted heterocycloalkyl; and
at least two of R¹, R², R³ and R⁵, together with the carbon atoms to which they are attached, are optionally joined to form a 5- to 7-membered ring; and
R⁴ is a protecting group,
in the presence of a coupling catalyst effective at catalyzing coupling between said C* atom according to Formula (IV) and a vinylalane of step (a).

20. The method of claim 19, wherein said compound has a structure according to: [chemical structure]
